(19) United States
(12) Patent Application Publication
(10) Pub. No.: US 2003/0008680 A1
(43) Pub. Date: Jan. 9, 2003

(54) Using identification information obtained from a portable phone

(76) Inventors: Stephen S. Huh, Boulder, CO (US); Patrick J. Kennedy, Boulder, CO (US)

Correspondence Address: SHERIDAN ROSS PC, 1560 BROADWAY, SUITE 1200, DENVER, CO, 80202

(21) Appl. No.: 09/865,234

(22) Filed: May 24, 2001

(51) Int. Cl. H04M 1/00

(52) U.S. Cl. 455/557; 455/574; 455/564; 455/569

(57) ABSTRACT

Wireless communications relative to a vehicle using a wireless communications device, a pocket for holding the wireless communication device and a docking station in communication with the pocket are provided. Together, the pocket and docking station form a docking assembly. The docking station is capable of identifying the particular model of wireless communications device held by the pocket, in order to select an appropriate command set or set of electrical characteristics for use in interacting with the wireless communications device. The pocket can include a processor for translating communications between the wireless communications device and the docking station. The docking station has processing capability and can communicate with different pockets and thereby different wireless communications devices. In at least one embodiment, the docking station manages voice recognition and text-to-speech commands to facilitate hands-free communications in the vehicle. The docking station can function as a communications hub involving a number of vehicle subsystems.

The present application relates to U.S. patent application Ser. No. 09/507,175 filed Feb. 18, 2000, the entire disclosure of which is incorporated by reference herein.

### FIELD OF THE INVENTION

The present invention relates to wireless communications systems. In particular, the present invention relates to a method and apparatus for providing hands free communications in a vehicle through any communication device capable of wireless communications.

### BACKGROUND OF THE INVENTION

Wireless telephones, including cellular telephones have become increasingly popular as a means for persons to remain in telephone, data and messaging contact with others, even when away from their home or office. In particular, wireless telephones allow persons traveling in vehicles to place and receive telephone calls, data and messages even while moving at high rates of speed. As wireless telephone technology has advanced, the telephones themselves have become smaller and smaller and more feature rich. In addition, and in particular with the implementation of various digital technologies, the stand-by and talk times provided by battery operated telephones have increased. The decrease in telephone size, the increase in features and the improvements in the battery life of wireless telephones have made the battery-operated wireless telephone an increasingly common communication device.

However, the small size and battery operated configuration of many wireless telephones can be disadvantageous when such telephones are used in automobiles. In particular, the small size of such telephones can make dialing and other operations difficult. In addition, even with advanced battery compositions and power-saving strategies, the batteries of wireless telephones eventually need to be recharged. Finally, the configuration of most wireless telephones requires that they be held to the face of the user in order to use the speaker and microphone that are integral to the telephone.

In order to address some of the disadvantages associated with the use of portable wireless telephones in vehicles, various “car kits” are known. At a most basic level, these car kits provide an interconnection between the telephone and the electrical system of the vehicle. These simple systems therefore allow the telephone to be powered by the electrical system of the car, and also to charge the telephone's battery. Other “car kits” provide a cradle fixed to the interior of the vehicle for holding the telephone, and require that the telephone be lifted from the cradle for use. Other simple “car kits” combine the interconnection to the vehicle's electrical system and the cradle for holding the telephone in a single device. However, these basic systems require that the user of the telephone remove at least one hand from the vehicle's controls in order to operate the telephone, and that the user hold the telephone to his or her face during calls.

At a next level, some conventional “car kits” provide basic speaker phone functions. These systems provide a microphone and speaker, external to the telephone, and adapted for use at a distance from the user. Therefore, with such a system, a telephone call could be conducted without requiring that the telephone be held to the face of the user. In order to provide a speaker phone capability, the device must generally interface with proprietary electrical contacts provided on the exterior of the telephone. Generally, telephone manufacturers provide electrical contacts for supplying power and for the input and output of audio signals on the exterior of the telephone. Additionally, various contacts for access to and the provision of telephone control signals may also be provided. Through these contacts, it is possible to control various functions of the telephone.

However, adaptors for physically securing the telephone to the interior of the automobile, and for electrically interconnecting the telephone to the automobile and to processors for providing desired functionalities can be expensive. In particular, the cost of providing a hands-free control system in a vehicle to accommodate a number of different wireless telephones can be cost prohibitive because the physical and electrical characteristics of telephones vary by manufacturer and by model.

In addition, the different telephone models available from a manufacturer may have differing electrical characteristics, even though the models have physical characteristics that allow them to be held by the same adaptor. Furthermore, telephones may function properly only when used in connection with a particular command set, and this command set may vary between telephones capable of physical interconnection with the same “car kit” type device. However, existing devices are incapable of distinguishing between telephones. In particular, conventional devices are incapable of interacting with both a first telephone having a first set of physical characteristics and that is functional using a first set of electrical characteristics and commands, and with a second telephone having the first set of physical characteristics and that is functional using a second set of electrical characteristics and/or commands. Instead, a user is required to select the device having the appropriate electrical characteristics and set of commands for the user's telephone. This situation is potentially confusing for consumers, who may assume that a device capable of physically interconnecting with a particular telephone should be capable of otherwise interacting with that telephone. In addition, retailers must stock, and manufacturers must provide, a different device for each unique combination of command set, electrical characteristics and physical characteristics found in telephones for which a “car kit” type device is to be supplied. In general, if a “car kit” device cannot support the particular command set, electrical characteristics and physical characteristics of a particular telephone, it will be non-operable with that telephone.

For the above-stated reasons, it would be advantageous to provide an improved method and apparatus for providing a hands-free wireless communications device in a vehicle. In addition, it would be advantageous to provide a method and an apparatus that allow for a single interface module containing many of the components necessary to provide the desired functions that can be used with any of a plurality of pocket devices provided for interfacing with supported telephones. Furthermore, it would be advantageous to provide a method and an apparatus that enable an adaptor to distinguish between different telephone models having similar physical characteristics, and to be capable of interacting with each of the different models. In addition, it would be advantageous to provide such a method and apparatus that can be implemented at an acceptable cost, that allows the user to easily and economically expand the provided functions, and that is reliable in operation.

### SUMMARY OF THE INVENTION

In accordance with the present invention, a system for providing hands-free wireless communications is provided. The disclosed system generally includes a docking station, a pocket or cradle and a wireless communications device. In general, the pocket is adapted to interface a particular wireless communications device or family of devices to a common docking station that may be functional with different pocket designs. The pocket and the docking station interact with the wireless communications device to economically provide for the hands-free operation of the wireless communication device.

A pocket in accordance with the present invention is adapted to be mechanically and electrically interconnected to a particular communications device or set of devices. Mechanical features of the pocket include surface features to allow the communications device to be held by the pocket and electrical connectors for mating with various electrical connectors provided with the communications device. Provisions for the electrical interconnection of the pocket and the communications device include, in addition to the above-mentioned electrical contacts, signal lines and processing capabilities. Accordingly, the pocket may provide for the passage of, e.g., radio frequency signals and digital data signals through the pocket without processing by the pocket. In addition, the pocket may include a processor for converting telephone control and other signals between the proprietary interface of the communications device and the application programming interface (API) of the system, allowing the pocket to pass telephone control and other information between the pocket processor and the docking station using a pocket-docking station communications bus. Because the physical and electrical characteristics of communications devices such as wireless telephones vary, a pocket may be provided for each unique combination of physical and electrical characteristics found among supported communications devices.

Also, a pocket may be provided in accordance with an embodiment of the present invention that is capable of operating in connection with different phone models, even though the different phone models have different electrical characteristics and/or are operated in connection with different command sets. According to one embodiment of the present invention, such a pocket queries a communications device when it is placed in the pocket to determine the particular model of the communications device. Based upon the information received in response to the query, the pocket adapts its electrical characteristics to those required by the portable communication device, and selects the command set required by the communications device for proper operation.

The pocket is also adapted for mechanical and electrical interconnection to the docking station. The mechanical interconnection may include the provision of a common mounting system for joining the pocket and docking station together, including electrical contacts, or simply electrical contacts where the docking station is remotely located from the pocket. Electrical interconnections between the pocket and docking station may also be according to a common standard, and may include signal paths for various signals. At least some of the signals present between the pocket and the docking station may be formatted according to the above-mentioned API. According to an embodiment of the present invention, the docking station may be interconnected to any of a plurality of pockets.

The docking station may contain a digital signal processor, Power PC, RISC or other processor for sending and receiving commands transmitted over the pocket docking station communications bus, and for controlling other functions. For instance, the digital signal processor of the docking station may perform various signal processing functions to remove noise, as well as acoustic echos and line echos, from audio signals passed between the telephone and a speaker, as well as from a microphone to facilitate hands-free communications. The digital signal processor may also serve to interpret voice commands issued by a user concerning control of the system. Other potential functions of the docking station digital signal processor include wireless data processing or forwarding, the storage of voice memoranda, text to speech functions, and for interfacing the system to other communication devices, such as personal information managers (PIMs), GPS receivers, vehicle communications busses, Bluetooth devices, and other devices. In accordance with one embodiment of the present invention, multiple processors, each adapted to perform particular tasks, may be provided as part of the docking station.

According to one embodiment of the present invention, the pocket in part controls access by a user to the functional capabilities of the system. Accordingly, a pocket may interconnect a communications device to a docking station in such a way that power may be supplied to the device, and audio communications passed to and from that device. However, the pocket may not allow for the recording of voice memoranda, even though the docking station may contain the processing, control and storage components necessary to provide that functionality. A second pocket may enable the user to access the voice memorandum recording capability of the docking station. Yet another, third pocket may additionally provide for the storage of voice memoranda in the pocket itself. Accordingly, this third pocket may allow a user to easily take recorded memoranda to, e.g., a docking station type device located in the user's home or office for playback of the memoranda. Still another pocket, used in combination with a suitable docking station, may enable a text to speech functionality. In this way, the system of the present invention allows a single model of docking station to optionally support a wide variety of communications devices and to provide a wide variety of functions. Therefore, the communications devices supported and the functional capabilities of the system can, at least in part, be determined by the pocket used as part of the system.

The system of the present invention allows a user to change, for example, his or her wireless telephone, while continuing to use the system, even where the physical and electrical characteristics of the new wireless telephone are different from the old, by purchasing a new pocket, while continuing to use the original docking station. In general, a user may gain access to additional capabilities by substituting a pocket enabling or providing a first set of capabilities for a pocket that enables or provides those additional capabilities. In this way, the system of the present invention enables a user to change his or her communications device without having to replace the docking station, and to upgrade the capabilities of the system by obtaining a pocket having the desired additional capabilities.

According to another embodiment of the system of the present invention, various models of docking stations may be available, allowing a user to determine the capabilities of the system at least in part by the docking station chosen. Accordingly certain interface modules may have less capabilities and be offered at a lower price than certain other interface modules that are more recent or that are more expensive but that offer expanded capabilities. Different models of interface modules may also be offered to provide or support new features. The various models of interface modules are preferably compatible, at least in part, with any pocket.

According to one embodiment of the system of the present invention, the system can provide a text to speech function to, for example, provide an audio output of textual data received by the communications device. This capability may be built into the docking station, or may be added to the docking station by the addition of a daughter board containing additional componentry to support the text to speech function.

The system is also capable of handling communications involving separately identifiable vehicle subsystems using processing or server functionalities of the docking station and/or associated daughter board. The vehicle having the vehicle subsystems has a unique IP address to allow communications over the Internet. In communications with the vehicle subsystem, the vehicle IP address is utilized outside the vehicle while, inside the vehicle, the communication can be mapped to, or otherwise associated with, the particular vehicle subsystem involved with the communication.

Additional advantages of the present invention will become readily apparent from the following discussion, particularly when taken together with the accompanying drawings.

### BRIEF DESCRIPTION OF THE DRAWINGS

FIG. 1A illustrates a system for providing wireless communications in a vehicle according to an embodiment of the present invention;

FIG. 1B illustrates a pocket according to another embodiment of the present invention;

FIG. 2 is a rear perspective view of a pocket according to an embodiment of the present invention;

FIG. 3 is a schematic illustration of a system for providing wireless communications in a vehicle according to an embodiment of the present invention;

FIG. 4A is a schematic representation of a system for providing wireless communications in a vehicle according to an embodiment of the present invention;

FIG. 4B is a schematic representation of a system for providing wireless communications in a vehicle according to another embodiment of the present invention;

FIG. 5 is a schematic illustration of a pocket according to an embodiment of the present invention;

FIG. 6 illustrates functional compatibilities between components of a system for providing wireless communications in a vehicle according to an embodiment of the present invention;

FIG. 7 illustrates the pocket communications state machine according to an embodiment of the present invention;

FIG. 8 illustrates the architecture of the docking station software according to an embodiment of the present invention;

FIG. 9 illustrates a typical communications scenario according to an embodiment of the present invention;

FIG. 10 illustrates a pocket worst case communications scenario;

FIG. 11 illustrates a docking station worst case communications scenario;

FIG. 12 is a flow chart illustrating aspects of the operation of an embodiment of the present invention; and

FIG. 13 illustrates functional compatibilities between components of a system for providing wireless communications in a vehicle according to a further embodiment of the present invention.

### DETAILED DESCRIPTION

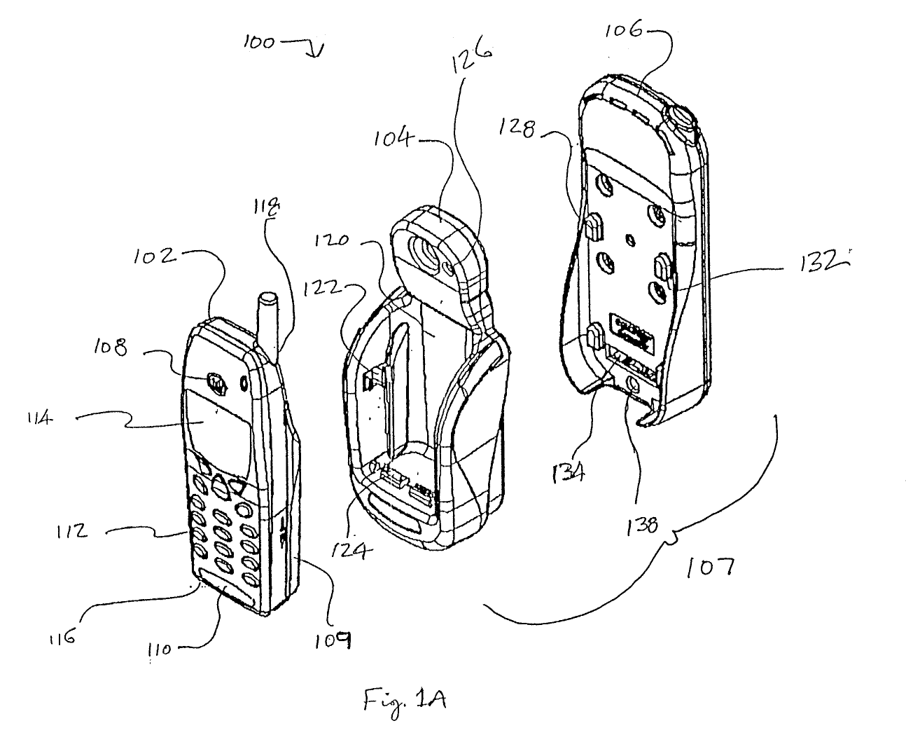

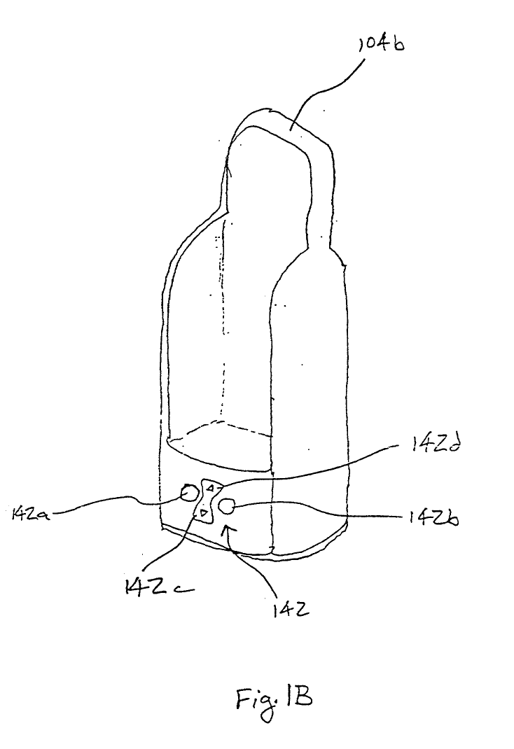

With reference to FIG. 1A, an embodiment of a system 100 for providing wireless communications in a vehicle is depicted. The system 100 generally includes any communications device capable of wireless communications (e.g., a portable communications device or wireless telephone) 102, a first holding assembly or pocket 104, and a docking station or interface module 106. For purposes of the present disclosure, the terms holding assembly, pocket, pocket member and adaptor shall be treated as being synonymous, or at least substantially functionally comparable. Considered together, the pocket member 104 and the docking station 106 form a docking assembly 107. The telephone 102 may have, or be compatible or otherwise operatively associated with, any current or future wireless technology, including, but not limited to, analog technologies such as the Advanced Mobile Phone System (AMPS), or digital systems such as a code division multiple access (CDMA) system, a time division multiple access (TDMA) system such as the Global System for Mobile Communications (GSM), a third generation (3G) system, such as wide band CDMA (W-CDMA), multicarrier CDMA, Time Division Duplex CDMA, or 3G EDGE (Enhanced Data Rates for GSM Evolution), or a combination of these and other air link technologies, such as the Bluetooth standard. In addition, the telephone 102 can be a wireless communications device other than a wireless telephone, such as a satellite telephone, a radio, a software defined radio, a personal digital assistant, with or without wireless telephone capability or other service. In general, the telephone 102 is designed by its manufacturer to operate on batteries 109 and to be small in size to allow for easy portability. In addition, the telephone 102 generally features a built-in speaker 108 and microphone 110 to provide for the input and output respectively of audio signals when the telephone 102 is held to the head of the user.

The telephone 102 includes a keypad 112 to allow the user to dial numbers and to access the internal capabilities of the telephone 102, such as stored directories of telephone numbers, voice mail, paging or other features that may be provided by the telephone 102. User-defined functions such as directories of the telephone numbers may be stored in internal memory provided in the telephone 102. In addition, a typical telephone 102 includes a visual display 114 for displaying the number to be called or other information, such as the contents of a memory location or the number from which an incoming call originates. The telephone 102 will generally include baseband frequency amplifiers associated with the speaker 108 and the microphone 110. The telephone 102 also includes a radio frequency section for transmitting and receiving signals at the telephone's 102 operating frequencies. An electrical connector 116 is generally provided to allow the telephone 102 to be electrically connected to external devices. For example, the telephone 102 may be connected to an external power supply through the electrical connector 116. In addition, the connector 116 generally includes contacts for the transmission of control and data signals to the telephone 102. In some telephones 102, provision may also be made for the interconnection of a coaxial radio frequency cable to a radio frequency port 118, allowing the telephone 102 to utilize an external antenna.

The pocket 104 is adapted to interface with the physical characteristics of the telephone 102. Accordingly, the pocket 104 generally includes a recess 120 shaped to receive the exterior of the telephone 102. The recess 120 may include surface features 122, such as friction pads or protrusions shaped to mate with receiving features on the telephone 102, to mechanically interconnect the telephone 102 and the pocket 104. The pocket 104 is also provided with an electrical connector 124 that mates with the electrical connector 116 of the telephone 102 when the telephone 102 is properly positioned within the recess 120 of the pocket 104. The pocket 104 may also be provided with a coaxial connector 126 for interconnection with a coaxial connector 118 on the telephone 102. Therefore, the pocket 104 is electrically connected to the telephone 102 through the electrical connections 116 and 124 and the coaxial connectors 118 and 126.

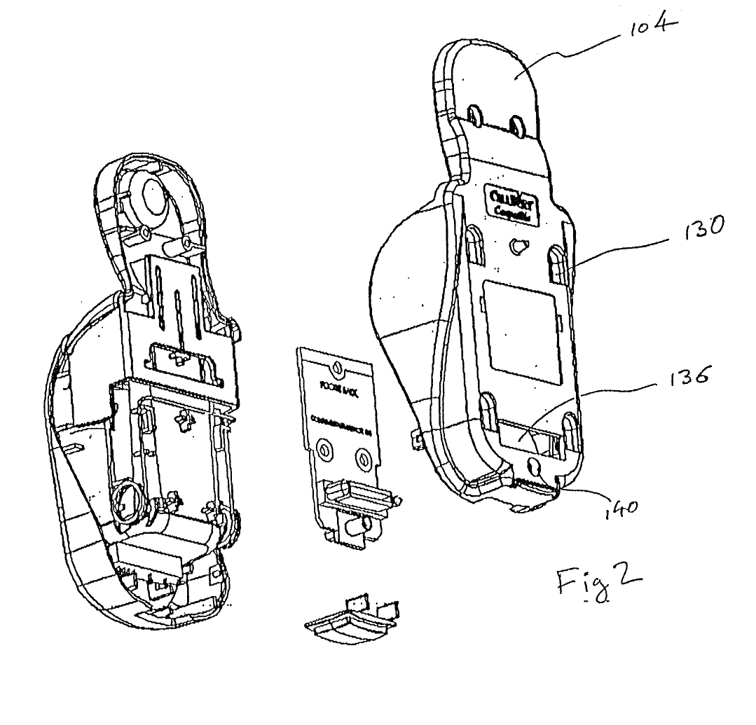

The docking station 106 includes locating protuberances 128 for receiving locating apertures 130 located on the back side of the pocket 104 (see FIG. 2). The locating protuberances 128, together with latch tabs 132 cooperate with the locating apertures 130 to mechanically interconnect the pocket 104 to the docking station 106. The docking station 106 also features an electrical connector 134 that mates with an electrical connector 136 located on the back of the pocket 104 (see FIG. 2). The docking station 106 additionally includes a coaxial connector 138 for connection to a cooperating coaxial connector 140 located on the back of the pocket 104 (see FIG. 2). The docking station 106 may also be provided with componentry to establish a wireless link with the telephone 102 or the pocket 104.

In the system of the present invention, the telephone 102 generally serves to transmit and receive radio frequency signals, and to demodulate and modulate those signals to and from the baseband frequencies (e.g., the audible frequencies or digital data communication frequencies). The telephone 102 then provides the baseband frequencies to the pocket 104 through the mating of the electrical connectors 116 and 124. Alternatively, the telephone 102 may provide the baseband frequencies to the pocket 104 over a wireless link. The pocket 104 also holds the telephone 102 securely in place. The electrical connector 136 and/or a wireless link, in cooperation with the electrical connector 134 on the docking station 106 and/or a wireless link provided by the docking station 106 or the pocket 104, completes the electrical interconnection of the telephone 102 to the docking station 106 either directly or through the pocket 104, and in turn to the vehicle. The docking station 106 also serves to mechanically interconnect the pocket 104, and in turn the telephone 102, to the vehicle, as the docking station 106 is generally rigidly affixed to the vehicle. The radio frequency connectors 118, 126, 138, and 140 also cooperate to carry radio frequency signals from the telephone 102 to an antenna mounted on the exterior of the vehicle. Therefore, in summary, the pocket 104 generally serves to mechanically and electrically interconnect the telephone 102 to the docking station 106 and in turn to the vehicle.

Referring now to FIG. 1B, an alternative embodiment of the pocket 104 of the present invention is illustrated. According to the embodiment of the pocket 104 illustrated in FIG. 1B, a plurality of control buttons 142 are provided. The control buttons 142 allow the user to access certain advanced features of the pocket 104 provided with select embodiments of the system 100 and in particular of the pocket 104. These advanced functions will be discussed in detail below.

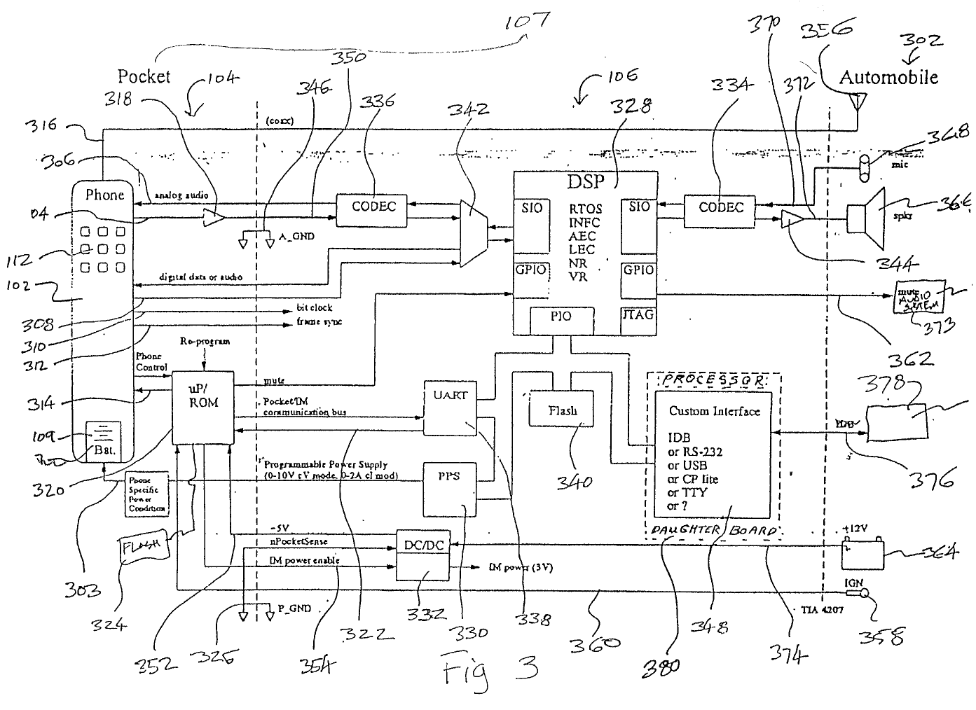

Referring now to FIG. 3, the major internal components of the telephone 102, the pocket 104, and the docking station 106, as well as relevant components integral to the automobile 302 are illustrated. As described generally above, the telephone 102 may provide various electronic signal paths. Therefore, the telephone 102 may accept power from an external source through a power supply line 303. The transmission of analog audio signals from the telephone 102 to the pocket 104 may be made through the analog audio output line 304, and analog audio signals may be transmitted from the pocket 104 to the telephone 102 through the analog audio input signal line 306. The telephone 102 may also be provided with one or more signal lines 308 for receiving and transmitting digital data or digital audio signals. Other signal lines that may be provided include a clock signal line 310, a frame synch signal line 312, and telephone control signal bus 314. Telephone control signals passed over the telephone control signal bus 314 may include signals to turn the telephone 102 on or off; to indicate that data is ready to be sent from the telephone, or that the telephone is ready to receive data; to request power or a change in power; to lock and unlock the telephone; to mute the telephone; to indicate an incoming call; to change the telephone language; to auto answer; to convey or request call timer information, current call status, call restriction data, telephone display data, calling number data, serial message data, cellular system information, or telephone system information; to request or control the telephone volume; to recall or write telephone numbers or other information from the telephone's memory; to simulate a telephone keypress; to dial a number; caller identification data; and to initiate the send command or the end command. The telephone control signal bus 314 may also pass identification-related information from the telephone to the pocket 104. The identification-related information may be used to identify the telephone 102, and may include information related to a model type and/or telephone type of the telephone 102. In addition, the identification related information may include a message obtained by the docking assembly 107 from the telephone 102. The message may, as will be appreciated by those of ordinary skill in the art, contain in a predetermined portion of the message identifying information. The message may also indicate a data format used by the telephone 102, and this data format information may be used to identify the telephone 102. All of the various electrical lines 303, 304, 306, 308, 310, 312 and 314 may be a part of the electrical connector 116 on the exterior of the telephone 102. The telephone 102 may also be provided with a radio frequency signal line 316 in the form of the coaxial connector 118.

As described above, the pocket 104 is provided with an electrical connector 124 for electrically interconnecting the pocket 104 to the telephone 102. Some of the electrical signals passing through the connector 124 are simply carried through the pocket 104 to the electrical connector 136, and thereby are passed on to the docking station 106 directly. Other of the signals are manipulated or processed within the pocket 104. For example, the analog audio output signal 304 is amplified in the pocket 104 by an analog audio amplifier 318. In addition, a microprocessor 320 processes telephone control signals on the telephone control signal bus 314 that are passed between the telephone 102 and the pocket 104, and communication on the pocket- docking station bus 322 passed between the pocket 104 and the docking station 106. Pocket memory 324 may be associated with the microprocessor 320. The pocket memory 324 may be any addressable storage space, such as ROM, RAM, EEPROM, flash memory, or a combination of memory types. All or a portion of the memory 324 may be removable from the pocket 104. The pocket 104 also includes a ground signal 326 for signaling to the docking station 106 through electrical connectors 134 and 136 the presence or absence of the pocket 104.

The docking station 106 includes processing hardware and software including at least one microprocessor and/or a digital signal processor 328, a programmable power supply 330, a DC to DC power converter 332, a near-end coder/decoder (CODEC) 334, a far-end CODEC 336, one or more universal asynchronous receivers/transmitters 338 (UART), and docking station memory 340. The docking station memory 340 may be any addressable storage space, such as ROM, RAM, EEPROM, flash memory or a combination of memory types. All or a portion of the memory 340 may be removable from the docking station 106. The docking station 106 also includes a multiplexer 342, an analog audio amplifier 344, and ground lines 326 and 346 for establishing a common ground between the pocket 104 and the docking station 106. The docking station 106 may additionally include an interface 348 for interconnecting the docking station 106 to various external subsystems 378. The interface 348 may be integral to the docking station 106. Alternatively, the interface 348 may conveniently be mounted to a daughter board 380 to facilitate expanding the capabilities of the docking station 106. The daughter board may also have a microprocessor including server capabilities. Instead of such a daughter board 380, all of its capabilities and the docking station components and their functionalities could be integrated on a single chip. In general, the provision of the interface 348 allows the docking station 106 to serve as a communications hub for various external subsystems 378. These external subsystems 378 may include personal computers, auto PCs, Global Positioning System (GPS) units, Personal Digital Assistants (PDA); devices for the storage of digital audio for playback through the automobile's stereo, such as devices storing music in the MP3 format; the data network or communications bus of vehicles, such as a controller area network (CAN), other data network or communications busses, visual displays; devices using the Bluetooth communications protocol or some other communications protocol; or other electronic systems. In connection with possible implementation of Bluetooth technology, such may be integrated with the docking station 106, as well as being incorporated with the pocket 104. In such a case, the Bluetooth technology need not be part of the wireless telephone 102 or other wireless communication device. According to this embodiment, the pocket 104 and the docking station 106 could cooperatively function to provide services for associated Bluetooth devices. In this configuration, the number of signal conducting wires is substantially reduced. However, one or more wires may be necessary or appropriate for providing charging functions and/or providing an external antenna connection.

With respect to facilitating communications with the vehicle having the wireless communications device 102, particularly communications to vehicle subsystems 378 using the Internet, the vehicle subsystems 378 can be configured to be separately accessible. These individualized communications are achieved, preferably not by assigning separate Internet protocol (IP) addresses to each of the vehicle subsystems 378, but by incorporating an address-related mapping technique. In accordance with the preferred embodiment, the particular vehicle has only one IP address, or at least the number of IP addresses associated with the vehicle and vehicle subsystems is less than the total number of vehicle subsystems. In the case in which the vehicle has only one IP address, it is necessary to be able to direct the received communication to the desired vehicle subsystem. This can be accomplished by assigning or correlating ports or other identifiers to each of the vehicle subsystems for which there is interest in allowing such communication. When a communication is received for a designated vehicle subsystem 378, the docking station 106 and/or associated daughter board 380 functions to map the contents of the received communication to the port or other identifier associated with a particular vehicle subsystem 378 that is to be the recipient of this communication. In a preferred embodiment in which it is desirable to communicate with a number or a fleet of vehicles from a common site outside the vehicle, each of the vehicles in the fleet would be assigned a separate IP address. However, the identifiers or ports associated with each of the vehicle subsystems in this fleet would have the same or corresponding port or other identifier. For example, vehicle subsystem 1 in vehicle 1 would have the same port number or other identifier as vehicle subsystem 1 in vehicle 2, although the IP addresses of vehicle 1 and vehicle 2 would be different. This configuration is highly beneficial in managing fleet vehicles, particularly sending/receiving information relative to each of a number of vehicle subsystems in a large number of vehicles. Relatedly, such configuration makes it easier to identify and locate each of the vehicle subsystems in a fleet since the same vehicle subsystem 378 in one vehicle has the same identifier as an identical vehicle subsystem in another vehicle in the fleet.

With regard to sending a first communication to a first vehicle subsystem located in a first vehicle, a communication can be prepared at a site remote from the vehicle. The communication packet includes an IP address for the first vehicle. The communication packet also includes address-related (e.g. port) information or other identifying information associated with the first vehicle subsystem that is to receive this first communication packet. The first communication packet is transmitted over the Internet to the first vehicle having the IP address in the communication packet. This communication packet is then received by the wireless telephone or other wireless communication device 102. Subsequently, a determination is made regarding the ultimate location or vehicle subsystem recipient of the first communication packet. This determination might be made by processing hardware and software in the docking station 106 and/or other processing hardware/software including possibly a server on the daughter board 380. As part of the processing or determination procedures, mapping or other correlation can be provided between the information in the first communication packet related to identifying the particular vehicle subsystem that is to receive the communication packet and a port or other identifier associated with this vehicle subsystem. After the mapping is completed, the communication packet can be directed to the determined first vehicle subsystem, which was designated as the recipient of this communication. As can be appreciated, in the case in which the same communication is to be sent to the same vehicle subsystem located in a number of vehicles in a fleet, only the IP address for each vehicle need be changed to its dedicated vehicle IP address. As can be further appreciated, when it is desirable to send a communication to a second vehicle subsystem located in the first vehicle, either at the same time or at different times, the same IP address associated with that first vehicle can be utilized, while the mapping function to enable the communication to be received by the second vehicle subsystem can be handled within the vehicle.

Similarly, in communicating from the vehicle to the site outside the vehicle, such as a common site associated with sending/receiving communications to/from a fleet of vehicles, and involving the transmission of data or other information from one or more vehicle subsystems in the vehicle, the network address translation (NAT) can also be accomplished. In particular, the server or other processing hardware/software conducts an address translation by which the vehicle IP address is provided before the communication is sent over the Internet. Such a communication could also include identifying information that identifies the accompanying data as emanating from the particular vehicle subsystem. Consequently, the communication to the site outside the vehicle is accomplished using a single IP address, regardless of which vehicle subsystem might be providing data to the site over the Internet.

Additionally, the docking station 106 is provided with various signal paths for interconnecting the docking station 106 to the pocket 104 and the vehicle or automobile 302. Signal paths between the pocket 104 and the docking station 106 include the analog audio input signal path 306 and the amplified analog audio output signal path 350. Digital data signal paths 308 and clock 310 and frame synch 312 signal paths may also be provided between the pocket 104 and the docking station 106. The pocket docking station communications bus 322 also runs between the pocket 104 and the docking station 106. The bus 322 may be a serial bus or any other appropriate bus. Various power lines may also run between the pocket 104 and the docking station 106, such as the telephone power supply line 303 and the pocket power line 352. The docking station power enable line 354 connects the microprocessor 320 of the pocket 104 to the DC to DC power convertor 332 in the docking station 106. The ground 326 and pocket sense 346 lines also pass between the pocket 104 and the docking station 106. Radio frequency signals are passed through the docking station 106 from the pocket 104 to an antenna 356 mounted on the automobile 302 over the radio frequency signal line 316. Additionally, a signal indicating the position of the automobile's 302 ignition switch 358 is passed through the docking station 106 to the microprocessor 320 of the pocket through the ignition signal line 360.

Signal paths between the docking station 106 and the automobile 302 include the radio frequency signal line 316, which passes from the phone 102, through pocket 104 and the docking station 106 to the antenna 356 on the automobile 302. In addition, near-end audio input 370 and audio output 372 lines connect the near-end CODEC 334 to the microphone 368 and the speaker 366, respectively. The audio output line 372 passes through an analog audio amplifier 344 before continuing on to the speaker 366. The mute line 362 connects the docking station microprocessor 328 to the entertainment system 373 of the automobile 302. The main power line 374 connects the DC to DC power convertor 332 of the docking station 106 to the electrical power supply 364 of the automobile 302. The ignition signal line 360 passes through the docking station 106, between the microprocessor 303 of the pocket 104 and the ignition switch 358 of the automobile 302. Additionally, one or more custom interface signal lines 376 may connect the interface 348 of the docking station 106 to various other subsystems 378 located in the automobile 302.

As a result of the above-mentioned signal paths, in addition to being mechanically interconnected to the automobile 302, the docking station 106 is electrically connected to certain of the automobile's 302 components. Therefore, the docking station 106 may be interconnected to an antenna 356 provided on an exterior of the automobile 302. Also, the docking station 106 is interconnected to the electrical power supply 364 of the automobile 302, and may also be connected to the ignition switch 358 of the automobile 302 to signal operation of the system 100 when the automobile 302 is running. Speakers 366 located within the automobile 302 may conveniently be utilized by the system 100 to provide an audible signal from the telephone 102. The speakers 366 may or may not be a part of the automobile's 302 audio entertainment system 373. Also, the speakers 366 may be part of a headset worn by the user. For receiving audible signals (e.g. the voice of a user), a microphone 368 may be located within the interior of the automobile 302, and that signal processed by the docking station 106 and provided to the telephone 102 via the pocket 104. The docking station 106 of the system 100 may also be interconnected to the audio system 373 of the automobile 302 to mute signals other than those transmitted from the telephone 102 to the speakers 366.

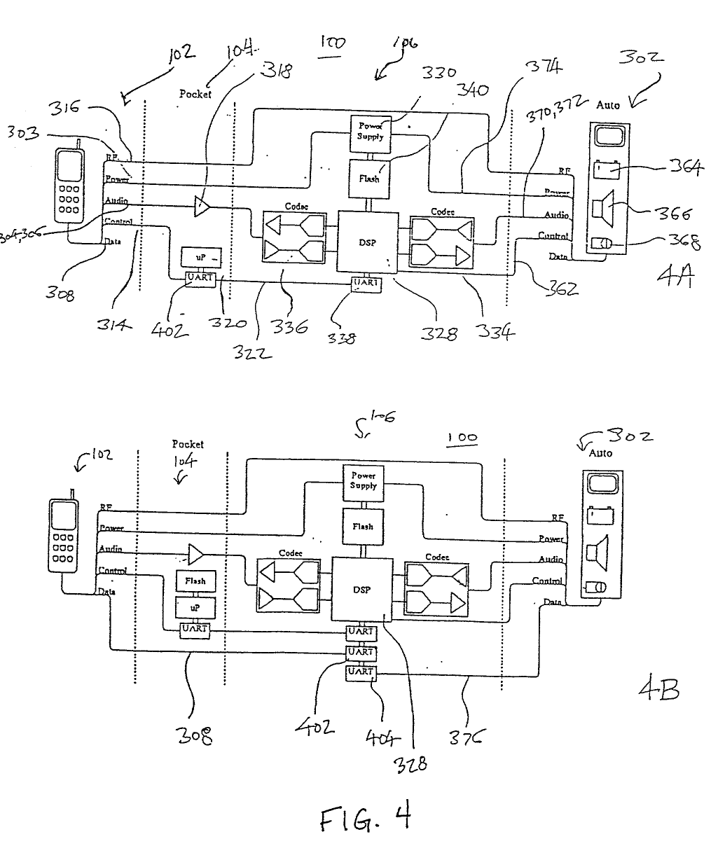

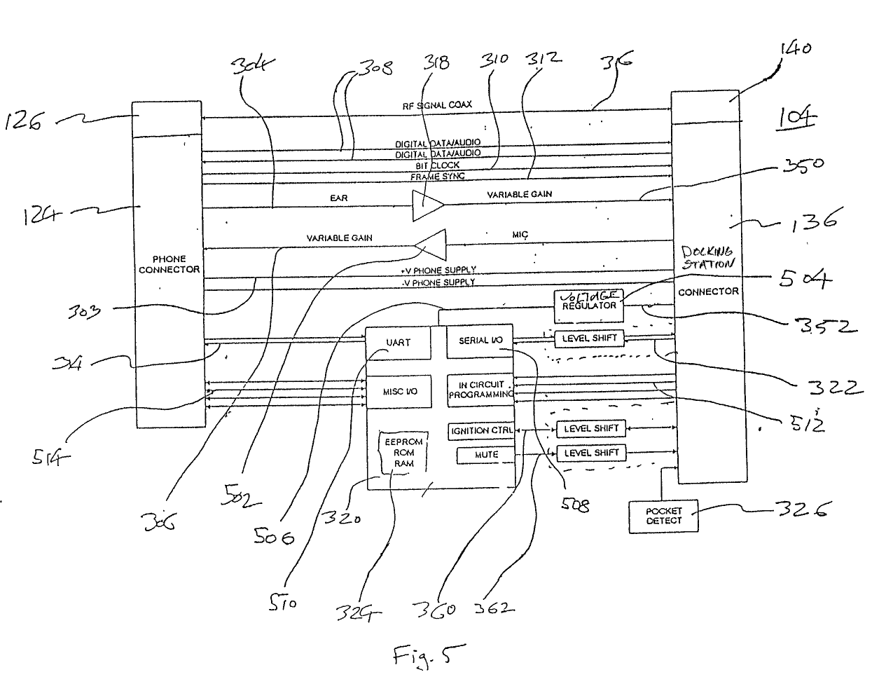

Preferably, the system 100 is provided in a variety of models offering differing capabilities to suit the needs and budgets of individual users. These differing capabilities are provided by varying the functionality supported by the pocket 104 and/or the docking station 106. Referring now to FIGS. 4A and 4B, embodiments of the system 100 having differing capabilities are illustrated schematically.

With reference now to FIG. 4A, a telephone 102, pocket 104, docking station 106, and automobile 302 of an embodiment of the system 100 are illustrated schematically. With respect to the telephone 102, the radio frequency 316, power 303, audio 304 and 306, control 314, and digital data signal lines 308 are illustrated. It is noted that, while the digital data path 308 is shown at the telephone 102, it is not passed through the pocket 104 to the docking station 106. This is because the embodiment of the pocket 104 illustrated in FIG. 4A does not support digital data signals 308, and thus does not provide a digital data line.

The pocket 104 of the embodiment illustrated in FIG. 4A includes signal paths for the radio frequency 316 and power 303 signals. For at least the incoming analog audio signal, an amplifier 318 is provided. Telephone control data line 314 is interconnected to the microprocessor 320 located in the pocket 104. Therefore, it can be seen that, in the embodiment shown in FIG. 4A, the pocket 104 provides interconnections to all of the telephone's 102 electrical inputs and outputs, except for those outputs for digital data or digital audio.

The pocket 104 of the embodiment shown in FIG. 4A amplifies audio signals provided from the telephone 102, and includes a microprocessor 320 for providing an interface for control data 314 passed between the telephone 102 and the docking station 106. As illustrated in FIG. 4A, a universal asynchronous receiver transmitter (UART) 402 may be associated with the microprocessor 320 for aiding the transmission of flow control data between the telephone 102 and the pocket 104. In one embodiment, a single UART 402, which is part of the microprocessor 320, is provided on the pocket 104 side of the telephone control signal path established between the pocket 104 and the docking station 106. Because a UART 338 is provided in the docking station 106, no additional UART is necessary. By eliminating an additional UART, the cost of the pocket 104, and in particular the cost of the microprocessor 320, can be kept to a minimum. However, in certain applications, such as those in which the docking station 106 is located at a distance from the pocket 104, it may be necessary to provide an additional line driver in the pocket 104.

The docking station's 106 major components are shown in FIG. 4A as the docking station microprocessor 328, the power supply 330, the near-end 334 and far-end 336 CODECs, the UART 338, and the docking station memory 340. The docking station 106 is also illustrated as providing a signal path for the radio frequency signal 316. The docking station microprocessor 328 provides a variety of advanced functions that will be described in greater detail below. The power supply 330 provides a constant voltage or a constant current, according to the requirements of the particular telephone 102, for powering the telephone 102 and charging the telephone's 102 battery 109. The CODECs 334 and 336 provide for the conversion of analog audio signals to digital signals that can be processed by the docking station microprocessor 328, and likewise convert digital audio signals emanating from the docking station microprocessor 328 into analog signals usable by the analog audio inputs of the telephone 102 or the speakers 366 of the automobile 302. As described above with respect to the pocket 104, the UART 338 of the docking station 106 facilitates the communication of telephone 102 control data between the pocket 104 and the docking station 106 across the pocket docking station bus 322. The docking station memory 340 allows voice memos or other data to be stored in digital form. In addition, the docking station memory 340 may be used to store word models and voice prompts used to support voice recognition features. As an additional function, the docking station memory 340 may be used to correct errors in the code resident in the docking station microprocessor 328.

The automobile 302 is, in the embodiment illustrated in FIG. 4A, shown as being connected to the radio frequency 316, power 374, audio 370 and 372 and control 362 line. However, the data line 308 is not shown as being interconnected to the data line 308 of the telephone 102. This is because the pocket 104 of the embodiment makes no provision for transmitting such data 308 to or from the telephone 102.

Referring now to FIG. 4B, a telephone 102, pocket 104, docking station 106, and automobile 302 of yet another embodiment of the system 100 are illustrated schematically. The system 100 illustrated in FIG. 4B includes all of the various signal lines and structures described above with respect to the embodiment illustrated in FIG. 4A. However, in addition, the embodiment illustrated in FIG. 4B includes a digital data line 308 from the telephone 102 through the pocket 104 to a second UART 402 located in the docking station 106. The second UART 402 of the docking station 106 is connected to a third UART 404 in the docking station 106. The interface signal line 376 runs between the third UART 404 of the docking station 106 and the automobile 302. Thus, the embodiment of the system 100 illustrated in FIG. 4B provides a direct path for digital data or audio from the telephone 102 to the docking station 106, including the docking station microprocessor 328, and from the docking station 106 to the automobile 302. The provision of these digital data lines 308 and 376 allows the system 100 to support additional features, as will be described in greater detail below.

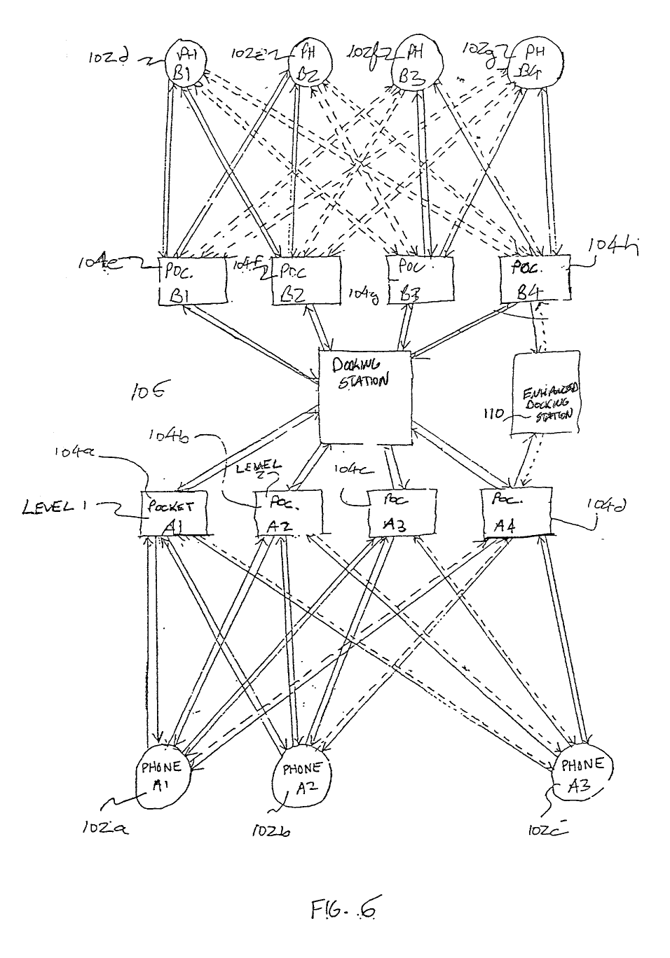

Referring now to FIG. 5, an embodiment of the pocket 104 of the present invention is illustrated schematically. As shown in FIG. 5, the pocket 104 generally includes an electrical connector 124 for providing electrical connectivity between the pocket 104 and the telephone 102. Additionally, a radio frequency connector 126 may be provided for the transmission of radio frequency signals across the pocket 104 to the docking station 106. The radio frequency signal line 316 thus travels between the radio frequency connector 126 at the interface of the telephone 102 and the pocket 104, and the radio frequency connector 140 at the interface of the pocket 104 and the docking station 106. An electrical connector 136 provides other electrical connections between the pocket 104 and the docking station 106. As discussed above, digital data lines 308 can be provided in the pocket 104 to pass digital data or digital audio signals directly from the telephone 102 to the docking station 106, without manipulation by componentry within the pocket 104. Other signal lines that are provided for transmission of signals across the pocket 104 without manipulation by the pocket 104 are the clock signal line 310 and the frame synch signal line 312. Also, one or more power supply lines 303 transmit power from the docking station 106 directly to the telephone 102.

As discussed above, an analog audio amplifier 318 receives analog audio signals from the telephone 102 over the analog audio analog output line 304. The analog signals received at the amplifier 318 are then amplified a selected amount and passed to the docking station 106 over the amplified analog output line 350. Also shown in FIG. 5 is an analog audio input amplifier 502 which may be provided to selectively amplify analog audio signals from the docking station 106 before they are passed to the telephone 102 over analog audio input line 306.

A voltage regulator 504 may be provided in the pocket 104 for providing the correct voltage level to power the microprocessor 320. For example, the voltage regulator 504 may take a 5 volt signal supplied by the DC to DC power convertor 332 in the docking station 106 over power line 352, and produce a 3 volt output. The 3 volt output may then be supplied to the microprocessor 320 over regulated power supply line 506.

The signals provided from the docking station 106 through the electrical connector 136 to the pocket 104 include communication signals transmitted over the pocket docking station communication bus 322. The communication bus 322 terminates in the microprocessor 320 at serial input/output pins 508. As will be described in greater detail below, the communication signals received at the serial I/O pins 508 are decoded before being sent to the microprocessor UART 510 for transmission to the telephone 102 over the telephone control lines 314. Other signal lines passing between the docking station 106 and the pocket 104 include a plurality of in-circuit programming signal lines 512, which may be used to program or re-program the pocket microprocessor 320. The ignition signal line 360 and mute line 362 are also provided. Additional I/O signal lines 514 may be provided between the microprocessor 320 and the telephone 102. A pocket detect ground 326 for interconnection to the docking station 106 is also provided. Additionally, memory 324 may be provided in the pocket 104 for use in association with the microprocessor 320. According to one embodiment of the pocket 104, the microprocessor 320 includes inputs for receiving signals from buttons 142 (see FIG. 1B) on the exterior of the pocket 104.

As mentioned above, the telephone 102 may generally be used to transmit and receive voice and data signals over an air link to a base station, such as a cell in a cellular phone system. Additionally, the telephone 102 will typically allow for the storage of indexed lists of phone numbers to provide the user with a customized list or directory of telephone numbers. The telephone 102 is also provided with a speaker 108 and microphone 110 to allow the user to engage in conversations over the telephone 102 when the telephone 102 is held to the face of the user. A keypad 112 is typically used to enter numbers and initiate dialing, answer incoming calls, and to enter phone directory information. A visual display 114 is also typically provided for displaying the number to be called, memory location entries, or other information. The phone 104 may be powered by a battery 109 so that the telephone 102 is easily portable.

However, the telephone 102 is typically not provided with features allowing for easy hand held use in an automobile. For instance, placing a call typically requires the user to enter the number using the keypad 112, or again using the keypad 112, to select from an entry in a user-defined directory. Using the keypad requires that the user remove his or her eyes from the road to view the keypad 112 and the display 114, and to remove a hand from the automobile's 302 controls to enter the number or select the desired option. This is, of course, disadvantageous where the user is driving the automobile 302. Although some telephones 102 are available with built-in voice recognition features, they are “near talk” systems, and are not well suited for use in vehicle or other “far talk” environments. Therefore, it is desirable to provide a system to allow the reliable hands-free operation of the telephone 102.

As can be appreciated, the telephone 102 may be produced by any one of a number of manufacturers, who each may produce a variety of different models. Accordingly, the physical shape of the telephone 102, as well as the physical configuration of the electrical connector 116 and the particular signal lines provided by the electrical connector 116 may vary greatly. Additionally, the communications protocol recognized by the telephone 102 is generally proprietary to the manufacture of the telephone 102 and may vary among telephone models 102 produced by a single manufacturer.

In order to accommodate the variety of physical, electrical, and communications protocol variations among telephones 102, the present invention provides a plurality of different pocket 104 configurations. Thus, a pocket 104 may be provided to mate with the various physical configurations of different telephones 102. Accordingly, the recess 120 and surface features 122 are generally determined by the physical characteristics of the telephone 102 meant to be accommodated by the particular pocket 104. In addition, the electrical connector 124 is physically configured to mate with the electrical connector 116 on the telephone 102. Where the telephone 102 provides a coaxial connector 118 for a radio frequency signal line, the pocket 104 may provide a mating coaxial connector 126. In this way, a particular telephone 102 may mechanically mate with the corresponding pocket 104.

As mentioned above, the particular electrical signal lines provided by telephone 102 and the communications protocol used by the telephone 102 may vary between manufacturers, and even among the various models of telephones 102 produced by a particular manufacturer. Therefore, in order to electrically connect the telephone 102 to the pocket 104 and the docking station 106 and in turn the automobile 302, provisions must be made to accommodate these differences. Accordingly, the pocket 104 may be designed to accommodate the particular configuration and type of electrical signal lines provided by the telephone 102. In a physical sense, this is done by connecting the provided signal lines (e.g. 304, 306, 308, 310, 312, 314, 303 and 316) to the corresponding contacts, if so provided, in the electrical connector 116 and 118 of the telephone 102.

Additionally, the pocket 104 is provided with a microprocessor 320 and associated pocket memory 324 for interfacing with the provided telephone control signals 314 of the telephone 102. In this way, the electrical and communications protocols of the telephone 102 can be accommodated by the particular pocket 104 designed for use with the particular telephone 102. Specifically, the memory 324 of the pocket 104 contains code that allows the pocket 104 to translate between commands formatted in the API of the system 100 and the proprietary communications interface of the telephone 102. Accordingly, the pocket 104 is capable of communicating with the telephone 102 using the command set of the telephone 102. In general, the pocket 104 is physically and electrically configured for use with a particular telephone or set of telephones. Furthermore, it is desirable that the docking station 106 be capable of operating with any of the provided pockets 104 and associated telephones 102. Providing a common docking station 106 may reduce the cost of the system 100, as only the pocket 104 need be varied to accommodate the wide variety of telephones 102 available in the marketplace. To further increase the advantages gained by using a common docking station 106, many of the components necessary to provide the functions of the system 100 are located in the docking station 106. Conversely, the number and cost of components necessary for the pocket 104 to provide the desired functions are kept to a minimum. In addition, although the docking station 106 may be capable of carrying out a certain number of functions, all of these functions may not be available to a user who has a pocket 104 that allows access to only a limited number of the potentially available functions. Also, the functions supported by a particular pocket 104 may be varied according to the operational functions available using the particular telephone 102 or according to the functions supported by the particular pocket 104.

With reference now to FIG. 6, a plurality of pockets 104a, 104b, 104c, 104d, 104e, 104f, 104g and 104h are shown, each having differing physical and/or functional compatibilities, but that are all physically and functionally compatible with a common docking station 106. The pockets A1 104a, A2 104b, A3 104c, and A4 104d may, for instance, be compatible with the physical characteristics of telephones A1 102a, A2 102b, and A3 102c produced by a single manufacturer A. Pockets B1 104e, B2 104f, B3 104g and B4 104h may be physically compatible with telephones B1 102d, B2 102e, B3 102f and B4 102g produced by manufacturer B, or alternatively produced by manufacturer A, but having different physical characteristics from telephone 102a, 102b and 102c. Although in the example the pockets 104a-d are physically compatible with the telephones 102a-c, and the pockets 104e-h are physically compatible with telephones 102d-g, all the various functionalities of telephones 102a-c may not all be supported by the pockets 104a-d and all the various functionalities of the telephones 102d-g may not all be supported by the pockets 104e-h. Similarly, the functional or other capabilities of the pockets 104a-h may not all be supported by all of the telephones 102a-g. In FIG. 6, the functional compatibilities between the individual pockets 104a-h and the individual telephones 102a-g are illustrated by arrows. A solid arrow from a pocket 104 to a telephone 102 indicates that all of the functions of the particular telephone 102 are supported by the particular pocket 104, while solid arrows from a telephone 102 to a pocket 104 indicate that all of the particular pocket's 104 capabilities are supported by the particular telephone 102. A dotted line from a telephone 102 to a pocket 104 indicates that only a subset of the pocket's 104 capabilities are supported by the particular telephone 102, while a dotted line from a pocket 104 to a telephone 102 indicates that only a subset of the particular telephone's 102 capabilities are supported by the particular pocket 104.

As an example, telephones A1 102a, A2 102b, and A3 102c may share common physical attributes, allowing any of those telephones to be mechanically interconnected to any of the pockets A1 104a, A2 104b, A3 104c, and A4 104d. However, the telephones A1 102a, A2 102b, and A3 102c may have differing functional capabilities. Likewise the pockets A1 104a, A2 104b, A3 104c, and A4 104d may support different functions. For instance, pockets A1 104a, A2 104b, and A3 104e may support all of the functional capabilities of telephones A1 102a and A2 102b, but only a subset of telephone A3's 102c capabilities while pocket A4 104d may support all of the functional capabilities of telephones A1 102a, A2 102b and A3 102c. Telephones A1 102a and A2 102b may support all of the functional capabilities of pockets A1 104a, A2 104b, and A3 104c, but only a subset of the functional capabilities of pocket A4 104d, while telephone A3 102c may support all of the functional capabilities of pockets A1 104a, A2 104b, A3 104c and A4 104d. Examples of the interaction between pockets 104 having differing functional capabilities and telephones 102 having differing functional capabilities will now be explained in the context of various examples.

The pocket A1 104a may be a level one pocket supporting only the most basic functions provided by the system 100. Thus, the pocket A1 104a may provide basic speaker phone functions when interconnecting telephones A1 102a, A2 102b or A3 102c to the docking station 106. The basic speaker phone functions may comprise the provision of a speaker 366 and microphone 368, to allow the user to carry on a conversation transmitted over a wireless link by the telephone 102 without having to hold the telephone 102 to his or her face. Thus, with reference now to FIG. 3, the pocket A1 104a may provide analog audio signal lines 304 and 306 to support analog audio signals from and to the telephone 102, where the telephone, e.g. telephone A1 102a, provides an analog audio input and output. The pocket A1 104a may also provide analog audio amplifiers 318 and 502 (see FIG. 5) to allow for the gain of the analog audio signals to be adjusted. The pocket A1 104a then provides connections for the analog audio signals to the docking station 106. Where the telephone A1 102 provides a digital input or output, for example, telephone A2 102b, the pocket A1's 104a digital audio signal lines 308 pass the digital audio signal directly to the docking station 106. In general, the capabilities and specifications of the telephone 102 are communicated to the docking station 106 by the pocket 104 via the pocket docking station communications bus when the pocket 104 is initially interconnected to the docking station 106.

The pocket A1 104a also may provide a power line 303 for charging the battery 109 of the telephone 102 and/or providing electrical power to operate the telephone 102. The pocket A1 104a additionally includes telephone control signal lines 314 between the telephone 102 and the microprocessor 320. Finally, the pocket A1 104a may provide a radio frequency signal line 316, where a radio frequency output connector 118 is provided by the telephone 102.

According to the embodiment of the system 100 having a level one pocket A1 104a, the telephone 102 is physically held in position in the automobile 302, and is provided with speaker phone functionality. Thus, where a telephone call is placed from a remote site to the telephone 102, the user must generally press a button on the keypad 112 of the telephone 102 to enable communications with the telephone at the remote site. The establishment of the communications link with the remote site is signaled to the pocket 104 by the telephone 102 over the telephone control signal lines 314. The form of the signal given by the telephone 102 is generally proprietary to the manufacturer of the telephone 102. Accordingly, it may consist of a serial digital message, or simply by a change in the voltage at an electrical contact on the telephone 102. The pocket 104, and in particular the microprocessor 320, is programmed to recognize the particular message sent from the telephone 102 to indicate that a call is in progress. The microprocessor 320 then converts the message from the telephone 102 into one complying with the application programming interface (API) of the system 100. This message may be transmitted from a serial I/O port provided on the microprocessor 320 over the pocket docking station communication bus 322 to the far-end UART 338 and from there to a parallel input/output port provided on the docking station microprocessor 328 of the docking station 106. The docking station microprocessor 328 reviews the call-in-progress message that originated in the telephone 102 and that was translated into the API of the system 100, and generally configures the system 100 so that it is ready to handle the call. In particular, the docking station microprocessor 328 activates the mute signal line 362 to mute any output from the automobile's 302 audio system 373. When the telephone provides an analog audio input 306 and an analog audio output 304, the docking station microprocessor 328 may also activate the analog audio output amplifier 318. Thus, where the telephone 102 provides an analog audio signal, that signal may be amplified by the analog audio amplifier 318 and passed to the docking station 106 wherein the analog signal is digitized by the far-end CODEC 336. The now digital audio signal is then passed to the multiplexer 342 and on to the docking station microprocessor 328 at a serial I/O port. The docking station microprocessor 328 then may perform a variety of signal processing functions on the audio signal. These functions may include acoustic echo cancellation, line echo cancellation, noise reduction, and frequency equalization. The digital signal processor may also provide partial full duplex operation, and automatic volume control functions. The processed digital audio signal is then passed from a serial I/O port of the docking station microprocessor 328 to the near-end CODEC 334 where 104 the digital audio signal is converted back into an analog signal. The analog signal may then be amplified to line level and conditioned in the analog audio amplifier 344 before being amplified by the audio system 373 or by a power amplifier associated with the speaker 366 and output by the speaker 366.

Voice signals from the user in the automobile 302 are picked up at the microphone 368, which may feature built-in noise reduction capabilities, and digitized by the near-end CODEC 344, before being passed to the serial I/O port of the docking station microprocessor 328. Again, various signal processing functions may be carried out in the docking station microprocessor 328, before the digital audio signal is passed to the multiplexer 342 and on to the far-end CODEC 336. The far-end CODEC 336 transforms the digital audio signal into an analog signal that is passed to the telephone 102 for transmission over the air link to the remote site.

Where the telephone 102 provides digital audio inputs and outputs, for example, telephones A2 102b and A3 102c, the transmission of signals through the system 100 is generally as described above, except that the digital audio signals are passed between the telephone 102 and the docking station microprocessor 328 via the multiplexer 342, without any intervening amplification, and without passing through the far end CODEC 336.

The level one pocket A1 104a may also provide the telephone 102 with power for charging the battery 109 and operating the telephone 102 over power line 303. In general, the microprocessor 320 of the pocket 104 will have been programmed to request the proper voltage or current from the programmable power supply 330 of the docking station 106. Of course, the power needs of the telephone 102 may vary according to the operational state of the telephone 102 or the charge of the battery 109. Therefore, the telephone 102 may request, for example, that power be supplied at a first voltage when the telephone 102 is in an idle state, and at a second voltage when the telephone 102 is in an active state. The signal requesting differing voltages may be passed from the telephone 102 over the telephone control signal lines 314 to the microprocessor 320 where the request is translated to the API of the system 100. The docking station microprocessor 328 may then control the programmable power supply 330 to provide the requested power. The pocket may also include a current limiter or voltage regulator as required.

Because the pocket 104 is designed to provide a predetermined set of functionalities and to be used with a predetermined telephone or set of telephones 102, the microprocessor 320 and in particular the memory 324 associated with the microprocessor 320 will have been programmed to translate the particular signals of the telephone 102 into commands included in the API of the system 100. In addition, the pocket 104 will have been programmed with the power requirements of the telephone 102. This information regarding the functions supported and requirements of the telephone 102 may be communicated over the pocket docking station communications bus 322 to the docking station microprocessor 328 when the pocket 104 is plugged into the docking station 106. The pocket 104 also communicates information regarding the functions supported by the pocket 104 to the docking station 106. In general, the docking station 106 is activated when the pocket 104 is plugged into the docking station 106 and the pocket sense ground 326 is established between the pocket 104 and the docking station 106.

A second pocket 104b, known as a level two pocket, may provide additional functionalities. For example, the pocket 104b may support audible prompts, voice commands and voice memorandum recording. As illustrated in FIG. 6, the functionalities of pocket A2 104b are fully supported by telephones A1 102a, A2 102b and A3 102c, even though it provides this additional functionality. Also, the docking station 106 may be identical to the one described with reference to pocket A1 104a. With respect to the basic speaker phone functions provided by the system 100 in connection with pocket A2 104b, the functions and interconnections are as described above with respect to the pocket A1 104a.

In order to support voice commands, the pocket A2 104b must be programmed to convey appropriate messages between the telephone 102b and the docking station 106. For instance, the pocket A2 104b must be capable of providing the telephone 102 with a telephone control signal directing the telephone 102 to pick up an incoming call. This is in contrast to the example given above with respect to pocket A1 104b in which the user must press a button on the keypad 112 of the telephone 102 to pick up an incoming call. In addition, the microprocessor 320 of the pocket 104b must include API commands for functions such as answering an incoming call. Apart from enabling additional functionalities such as voice recognition and voice memorandum recording, the pocket A2 104b is, according to one embodiment of the present invention, the same as pocket A1 104a.

Audible voice prompts are, according to an embodiment of the system 100 of the present invention, provided to guide a user operating the system 100. Audible prompts are particularly advantageous when used in connection with voice recognition functions because they facilitate operation of the system 100 without requiring that the user look at the system 100 itself. For example, the system 100 may acknowledge commands given by the user, or provide the user with information concerning the status of the system 100. The audible prompts may be pre-recorded and stored in the pocket memory 324 and/or the docking station memory 340, with or without compression. Alternatively or in addition, the audible prompts may be generated from text stored in memory 324 or 340 using a text to speech functionality (described below). According to one embodiment, the voice prompts are stored in easily changed memory 324 or 340 cartridges, to allow the existing system 100 to be upgraded, or to accommodate a different or an additional language.

The docking station 106 may include speech recognition functions to enable the system 100 to recognize voice commands. The docking station used in connection with pocket A2 104b may be identical to the docking station 106 used in connection with pocket A1 104a. Alternately, the docking station 106 used in connection with pocket A2 104b may be enhanced to provide voice recognition functions. Even if the docking station 106 is provided in various models offering differing capabilities, any docking station 106 is preferably compatible, at least in part, with any pocket 104. In general, speech models are stored in the docking station memory 340 or the pocket memory 324 to enable the system 100 to recognize universal commands such as “answer call” or “place call.” Different memory 324 or 340 cartridges may be provided to conveniently upgrade the speech models or change them to a different language. In addition, provision may be made in the docking station 106 for storing user defined commands, such as “call home” or “call Mary.” According to one embodiment of the present invention, the user defined commands and voice memoranda may be stored in removable memory 324 or 340 to facilitate their use in other systems 100 or in compatible devices, to archive memoranda, or to allow the use of different command sets. The removable memory 324 or 340 may comprise a RAM memory card. The pocket A2 104b may be provided with buttons 142 (see FIG. 1B) to enable the user to signal the system 100 to enter a voice command mode or voice memo record mode.

The operation of the system 100 in processing a voice command will now be explained in the context of an example. Where a telephone call is not in progress (i.e. the telephone 102 is on-hook), a user may command that a general voice recognition mode be entered by uttering a special initiator word (e.g., “CellPort”). The system 100 may also be provided with a “barge-in” capability to allow voice recognition mode to be entered even while a telephone call is in progress (i.e. the telephone 102 is off-hook). Alternatively, the user may press a button 142a provided on the exterior of the pocket 104b to place the system 100 in voice recognition mode. Upon receiving the signal to enter voice recognition mode, the processor 320 sends a message across the pocket docking station communication bus 322 to the docking station microprocessor 328 via the UART 338. The message sent by the microprocessor 320 is formatted according to the API of the system 100. Upon receiving the message to enter voice recognition mode, the docking station microprocessor 328 activates or otherwise communicates with the microphone 368. When a voice command is used, the docking station microprocessor 328 will cause the system 100 to enter a general voice recognition mode after a prescribed voice command has been issued by the user.

Voice commands issued by the user are converted into analog electrical signals by the microphone 368 and passed through the near-end CODEC 334, where the analog signals are digitized. The digitized voice commands are then compared in the docking station microprocessor 328 to the standard and customized speech models stored in the flash memory 340. If, for example, the user issues the command “call home,” the docking station microprocessor 328 will attempt to match those words to the stored word models. Upon finding a match, the docking station microprocessor 328 will initiate action according to the command. Thus, when the command “call home” is received, a signal to initiate a telephone call will be formatted in the API of the system 100, and passed to the microprocessor 320 of the pocket A2 104b, where the API command is translated into a signal understood by the telephone 102. Where the telephone number associated with “home” is stored in memory 324 or 340, the command to the telephone 102 may consist of the digits of the telephone number and the send command. Alternatively, where the telephone 102 allows access to telephone directories stored in its internal memory, the command from the docking station microprocessor 328 may be in the form of a command to retrieve a number from a specified memory location in the telephone 102 and to initiate the send function.

The functions provided by the level two pocket A2 104b may also include provisions for voice memo recording. Thus, by pressing the associated buttons 142b, or by issuing the appropriate voice command, such as “take a memo”, the system 100 may be configured to record a voice message. Such a capability is useful, for instance where a user wishes to give him or herself a reminder to do something without having to write the reminder down with pencil and paper. The voice memorandum capability is also useful for recording directions or a telephone number given by the person at the other end of the communications link. In voice memo recording mode, the voice message is converted to an analog electrical signal by the microphone 368 and transmitted to the near-end CODEC 334 where the signal is digitized. The digital voice memo is then processed and compressed by the docking station microprocessor 328 and stored in memory 340. When the user wishes to retrieve the voice memo, the user may press a button 142c on the pocket A2 104b causing a command to be sent from the microprocessor 320 across the pocket docking station communication bus 322 to the docking station microprocessor 328, in the API of the system. The docking station microprocessor 328 then retrieves the message from memory 340, decompresses the message, performs signal processing functions, and provides a digital output of the message to the near-end CODEC 334, which converts the memo to an analog signal that is then amplified by the amplifier 344 and output at the speaker or headset 366. Where the command to replay a previously recorded voice memo is in the form of a voice command, the recognition of the voice command by the docking station microprocessor 328 initiates the retrieval of the voice message from memory 340 for playback through the speaker 366. In addition or as an alternative to playback through the speaker 366, the memorandum may be transmitted to another device for playback. For example, the memorandum could be transmitted by the telephone 102 to a remote telephone or device, or it could be transmitted to a computer or other external subsystem 378 for playback.

A next level of functionality may be provided by the system 100 in connection with a pocket A3 104c. The additional functions provided by the pocket 104c may include storage for voice memos, directories and customized voice commands in the pocket 104. As illustrated in FIG. 6, the functionalities of pocket A3 104c are fully supported by telephones A1 102a, A2 102b and A3 102c. The docking station 106 may be identical to the docking station used in connection with any of the pockets A1-A4 104a-c and B1-B4 104e-h. The functionalities pocket A3 104c shares with pockets A1 104a and A2 104b may be executed in the same manner as described above.

The pocket A3 104c is provided with memory 324 sufficient to allow the recordation of voice memos and for the storage of voice commands and directories programmed by the user in the pocket A2 104c. In addition, a UART may be provided in the pocket A3 104c to synchronize the transfer of voice memos and voice command data between the docking station 106 and the pocket 104. In general, the voice memo recording function using the pocket A3 104c is identical to the function when carried out by pocket A2 104b. However, the provision of additional memory 324 in the pocket A3 104c allows for voice memos to be stored in the pocket A3 104c. According to one embodiment of the present invention, voice memoranda may be stored in the pocket memory 324 as each memorandum is recorded. Alternatively, voice memoranda may be stored initially in the docking station memory 340, and later transferred to the pocket memory 324 automatically when the system 100 has the resources available to complete such a transfer. As yet another alternative, the user may initiate a transfer of voice memoranda data to the memory 324 in the pocket A3 104c by, for example, pressing a button provided on the pocket A3 104c or by issuing an appropriate voice command. Control logic provided in the pocket microprocessor 320 and/or the docking station microprocessor 328 may be provided to control whether data already written to the memory 324 is overwritten by new data. For example, the user may be notified when the memory 324 is full, and given a choice as to whether old data should be overwritten. After the voice memoranda has been transferred to the pocket memory 324, the pocket A3 104c, which is easily disconnected from the docking station 106, can then be taken to, for example, the user's office. The pocket A3 104c may then be interconnected to a device in the office having a microprocessor and associated speaker, similar to the docking station 106, for playback of stored messages. The UART 402 in the pocket A3 104c allows the memo data to be transmitted over a dedicated line for storage in the pocket A3 104c.

The ability to store customized directories and voice commands in the pocket A3 104c allows a user to use those customized features in any car equipped with a suitable docking station 106. Therefore, by moving the telephone 102 and the pocket A3 104c different users may share an automobile, while retaining access to their own directories and commands. This feature is also useful where a user rents an automobile provided with a docking station 106, as all of the user's personalized information can be carried in the pocket A3 104c.

A further level of functionality may be provided by the system 100 in connection with pocket A4 104d. As illustrated in FIG. 6, the functionalities of pocket A4 104d are fully supported by telephone A3 102c, but only partially supported by telephone A1 102a and telephone A2 102b. Pocket A4 104d fully supports the functionalities of telephones A1-A3, 102a-c. The additional functionalities provided or enabled by pocket A4 104d may include text to speech capability. The text to speech function allows the system 100 to convert information received in the form of written text to audible speech. However, the text to speech function generally requires a telephone 102 capable of receiving textual information. According to the example illustrated in FIG. 6, telephone A3 102c is the only telephone from manufacturer A having e-mail or Internet browsing capabilities. In the example of FIG. 6, telephones A1 102a and A2 102b lack the capability to receive information in the form of text and therefore cannot fully support the text to speech function. However, it should be noted that some text to speech capability may be possible in connection with telephones A1 102a and A2 102b, for example where information in the display 114 of the telephone 102a or 102b, such as caller ID information, is provided at the electrical connector 116 of the telephone 102a or 102b, in which case the information can be presented to the user as audible speech. In addition, the text to speech function may service other subsystems 378 capable of providing textual output. Generally, the pocket 104d provides all of the functions described above with respect to pockets A1-A3, 104a-c.

The pocket A4 104d is provided with commands in the microprocessor 320 to support the receipt of textual information from the telephone 102c. The information received by the telephone 102c is formatted into the API of the system 100 by the microprocessor 320 and transmitted to the docking station 106 over the digital data signal line 308 or the pocket docking station communication bus 322. According to one embodiment of the present invention, the docking station 106 for use in connection with the pocket A4 104d includes an additional processor at the custom interface 348, which may be conveniently mounted on a daughter board 380, for performing the text to speech function. Generally, the processor at the custom interface 348 transforms the received text into digitized speech, which can then be passed to the docking station microprocessor 328, and from there to the near-end CODEC 334 for conversion to an analog audio signal. The analog audio signal is then output through the speakers 366. The use of an additional processor at the custom interface 348, which can be added to the normal docking station 106, is desirable in that it allows for the use of a specialized processor for handling the relatively complex text to speech translation function. Additionally, it allows docking stations 106 not intended for use with a text to speech enabled pocket 104 and telephone 102 to be produced at a lower cost. As alternatives, the docking station microprocessor 328 may be sufficiently powerful or robust to perform the text to speech function, or an enhanced docking station 110, having a text to speech enabled docking station microprocessor 328 may be offered in addition to the normal docking station 106. As a further alternative, an enhanced microprocessor 320 in the pocket, or an additional microprocessor, may be provided in the pocket A3 102c to handle the text to speech function. Apart from enabling additional and/or different functionalities, such as text to speech, the pocket A3 104c is generally the same as pocket A1 104a and A2 102b.

In connection with the above description of pockets A1-A4 104a-d and their functional capabilities, a user may generally choose the capabilities of the system 100 according to the user's needs and desires by choosing the appropriate pocket A1-A4 104a-d. Thus, a user owning any of telephones A1-A3 102a-c can choose a system 100 having basic hands-free capabilities by purchasing pocket A1 104a and docking station 106. By purchasing pocket A2 104b and a docking station 106, a user may obtain voice command and voice recording capabilities. The use of pocket A3 104c in connection with station 106 provides the user with a system 100 that allows voice memos and programmed voice command information to be stored in the easily transported pocket A3 104c. Accordingly, it is the pocket A1 104a, A2 104b, or A3 104c that determines what capabilities the system 100 provides when used in connection with either a telephone A1 or A2 102a or 102b. Also, when purchasing a new pocket 104 in order to obtain advanced features or to accommodate a different telephone 102, the user need not replace the docking station 106. Furthermore, the same docking station 106 may be used in connection with pockets A1-A3 104a-c.

A system 100 providing text to speech capabilities may be obtained by using a docking station 106 with an additional or an enhanced processor or an enhanced docking station 110, pocket A4 104d, and telephone A3 102c. Although the docking station 106 or 110 used in connection with pocket A4 104d in this example provides enhanced capabilities, it should be noted that, except for the text to speech function, pocket A4 104d is fully supported and fully compatible with the general docking station 106. Similarly, pocket A4 104d can be used with telephones A1 or A2 102a or 102b.

With continued reference to FIG. 6, the relationship between telephones B1-B4 102d-g, pockets B1-B-4 104e-h, and docking station 106 are illustrated. In general, pockets B1-B4 104e-h provide the four levels of functionality described above with respect to pockets A1-A4 104a-d, but are designed to physically and electrically interconnect with telephones B1-B4 102d-g produced by manufacturer B. However, the pockets B1-B-4 104e-h are designed to work with the same docking station 106 as pockets A1-A4 104a-d.

As shown in FIG. 6, pockets B1 and B2 104e and 104f are fully compatible with telephones B1 and B2 102d and 102e, but only partially compatible with telephones B3 and B4 102f and 102g. Additionally, pockets B3 and B4 104g and 104h fully support the functional capabilities of telephones B3 and B4 102f and 102g, but are only partially compatible with telephones B1 and B2 102d and 102e. This situation may occur, for instance, where telephones B1 and B2 102d and 102e feature an older interface used by manufacturer B, while telephones B3 and B4 102f and 102g use a newer interface. Therefore, even though the telephones B1-B4 102d-g may have the same physical characteristics, changes to the interface used to control and send data to and from the telephones 102d-g will affect their compatibility with the pockets 104e-h. According to an embodiment of the system 100, where a user has upgraded their telephone 102, but wishes to use a pocket having an interface adapted for an earlier model of the telephone 102, provided that the telephone 102 and pocket 104 are still physically compatible, the pocket 104 can be upgraded by modifying the memory 324 of the pocket 104 to enable the pocket 104 to properly interact with the telephone 102.

Modifications to the memory 324 may be made by transmitting the upgrade to the memory 324 through a physical connection to a component of the system 100. For example, the pocket 104 may be connected to a personal computer that has been used to download a programming upgrade from an Internet website, or to read new programming code distributed on a floppy disk, CD ROM, or other storage medium. Alternatively, the docking station 106 could be connected to a personal computer, and new programming code loaded onto the memory 340 of the docking station 106. Regardless of whether the pocket 104 or the docking station 106 is used to initially receive the updated programming code, the programming code resident in the pocket memory 324, the docking station memory 340 or both can be modified using the above-described methods. Where a telephone 102 capable of downloading information from the Internet is available, that telephone 102 may be used to download new programming code to upgrade the pocket 104 and/or the docking station 106. Another method of upgrading the programming code of the system 100 is for the user to purchase an upgraded pocket 104 that contains new programming code for upgrading the code stored in the docking station memory 340. Similarly, a docking station 106 containing the necessary code may be used to upgrade the code resident in the pocket memory 324. As yet another method of upgrading the code resident in the memory 324 or 340, all or portions of the memory 324 or 340 may be augmented or replaced by memory 324 or 340 having upgraded programming code.

However, modifying the memory 324 to properly translate between a new telephone interface and the API of the system 100 will not be sufficient where the manufacturer has made changes to the physical configuration of the telephone 102. Also, changes to the memory 324 alone will not be sufficient where the user has, for instance, purchased a new telephone from a different manufacturer having a different physical configuration. In these instances, compatibility with the system 100 may be regained by purchasing a new pocket 104 that is compatible with the user's new telephone 102. The purchase cost of a pocket 104 is preferably much less than the purchase cost of both a pocket 104 and a docking station 106, as the docking station 106 originally purchased by the user may be used with the new pocket 104.

The multiple-processor multiple-bus configuration of the system 100 allows the system 100 to be designed using modular units. In particular, the system 100 provides a pocket 104 for at least every combination of physical and electrical characteristics found in supported telephones 102. The system 100 allows the use of a common docking station 106 by converting the unique physical and electrical characteristics of supported telephones 102 to a common electrical and physical interface at the pocket 104. Therefore, common system components can be placed within the docking station 106, while particular attributes required by particular telephones 102 can be accommodated by the pocket 104. In this way, the cost of the system 100 can be reduced and the flexibility increased.

The application programming interface (API) of the system 100 is the common language used to communicate commands and information between the pocket 104 and the docking station 106. Translation between the interface of the telephone 102 and the API of the system 100 is performed in the pocket 104, and in particular in the microprocessor 320. After translation in the microprocessor 320, commands and information originating at the telephone 102 can be transmitted using the API to the docking station 106 over the pocket docking station communication bus 322. Commands and data originating at the docking station 106 and at the system 100 follow the reverse course, with commands and data formatted in the API of the system 100 being translated into the telephone's 102 unique interface at the microprocessor 320 of the pocket 104.

Where the system 100 is to be interconnected with subsystems 378 in addition to the telephone 102, an additional processor or custom interface 348 may be provided to perform translation between the API of the system 100 and the interface of the subsystem 378 to which the system 100 is interconnected. Preferably, the custom interface 348 may be provided in the form of an add-on or daughter board 380 that can be interconnected to the docking station microprocessor 328 using provided electrical contacts. Thus, connectivity to various other subsystems 378 may be achieved without requiring changes to the docking station's 106 main components or to the pocket 104 presently in use. Alternatively, the subsystem 378 can communicate using the API of the system 100, without requiring any translation. For example, the interface required to communicate with an external subsystem 378 may be resident in the docking station 106. The custom interface 348 and daughter board 380 may simply provide a mechanical connection, or may not be provided at all where the external subsystem 378 interface is resident in the docking station 106.

As mentioned above, the external subsystem 378 may comprise a variety of electronic devices. The subsystem 378 may include protocol based units and close-ended devices. The protocol based units can include networks and busses having associated components or peripheral devices that are interconnected. The close-ended devices are referred to herein as devices that do not have International Standards Organization (ISO) network layering and typically constitute a terminating communication node in the context of data flow ending or originating from such device, and not typically acting as a link or pass-through device for information or data transfers. An example of such a close-ended device might be a global positioning system (GPS) that is useful in providing vehicle location information, or a hardware device, such as a vehicle sensor, from which data can be obtained for a particular vehicle component to which the sensor is operably connected.

In addition to the GPS, the external subsystem 378 may include an Internet Protocol (IP) stack comprised of a number of network layers that are commonly involved in transfers using the Internet. The external subsystem 378 can also include an intelligent transportation system data bus (IDB) and/or an on-board diagnostics (OBD) system that are involved with monitoring and providing information related to vehicle components.

The external subsystem 378 may also include a controller area network (CAN) found in at least some vehicles and which includes a bus along which a number of vehicle elements communicate for supplying information concerning such elements. The CAN is operatively connected to each of a plurality of vehicle devices that transmit, receive, or both transmit and receive desired data. For example, the vehicle devices include transducers or other physical devices that detect and provide information useful to applications software for processing to obtain information that is then transmitted for storing in memory for later transmission, or even for immediate transmission without processing, upon receipt of the proper request or command. Other available networks could be utilized, instead of CAN, such as Arcnet, which has a protocol similar to CAN. Where the external subsystem 378 includes one of a plurality of vehicle busses, the hardware supplied for interconnecting the external subsystem to the docking station 106, such as the daughter board 380, may include provisions for signaling to the docking station microprocessor 328 the format of the output required by the particular external subsystem 378. For example, the daughter board 380 may comprise cabling, and the presence or absence of a resistor between two signal paths may be used to indicate to the microprocessor 328 the proper voltage at which signals are to be transferred to and from the external subsystem 378. For further information regarding obtaining information or data from vehicle devices, see U.S. Pat. No. 5,732,074, filed on Jan. 16, 1996 and assigned to the assignee of the present invention. The external subsystem 378 may also comprise an analog/digital converter (ADC), a standard serial bus, a universal serial bus (USB), an RS232 connection, a user datagram packet/Internet protocol stack, as well as one or more other custom proprietary devices.

Other devices that may comprise the external subsystem 378 may include a PCMCIA (Personal Computer Memory Card Interface Association) unit, which may include a storage device for storing desired information or data. The external subsystem 378 may also include a device capable of communication using the Bluetooth protocol, which provides a standard protocol for the wireless communication of information between disparate devices.

The protocol used for communications between the pocket 104 and the docking station 106, according to an embodiment of the present invention, is half duplex. Accordingly, there can only be one message in the pocket-docking station bus 322 at any one time. Normally, messages are responded to with either an ACK, acknowledging correct receipt of the message, or a NACK, indicating a problem. A response may be suppressed by issuing a “do not acknowledge” command with the message. In general, the combined message-response pair must be completed before another message can be placed on the bus. A time out period for failed messages may be established, and messages not receiving an acknowledgment within a selected period of time (e.g., 1 second), will be retransmitted up to a selected number of times (e.g., 8 times).

According to an embodiment of the present invention, the pocket 104 acts as the bus master, and the docking station 106 acts as the slave. As master, the pocket 104 may issue API commands to the docking station 106 at any time. Periodically, the pocket 104 issues a bus grant message to the docking station 106 after which the docking station 106 may send a command to the pocket 104. After receiving the bus grant message, the docking station 106 can either send a pending message or reply with a bus release message. According to an embodiment of the present invention, the bus grant message is sent once every second, and the docking station 106 has 500 ms to issue a pending message or a bus release message.

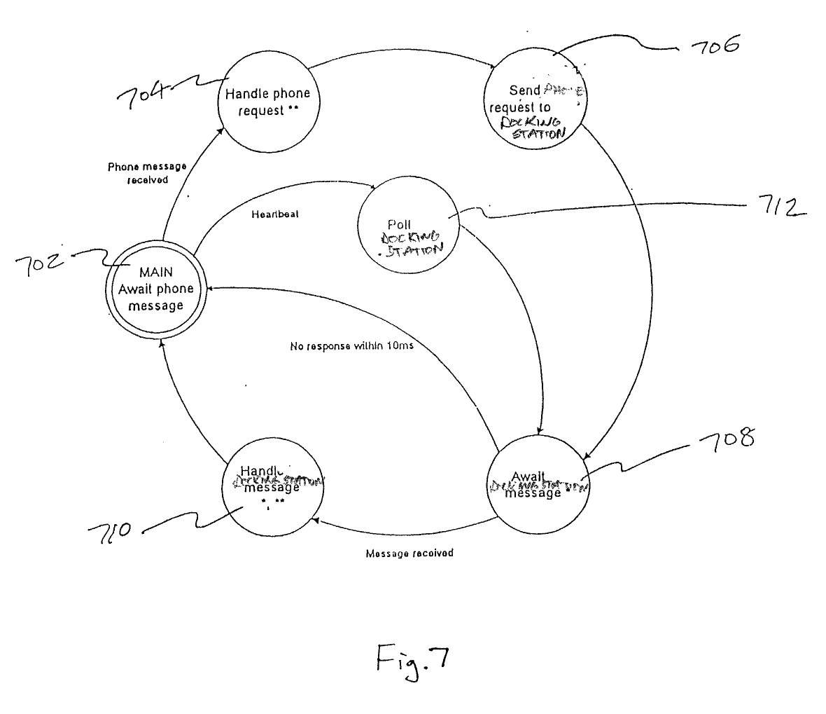

With reference now to FIG. 7, the pocket communications state machine in accordance with another embodiment of the present invention is illustrated. Generally, in the system 100, the pocket 104 and the docking station 106 are in a master and slave relationship. As shown in FIG. 7, at state 702, the pocket 104, and in particular the microprocessor 320, awaits a message from the telephone 102. Upon receiving a telephone message, the pocket 104 enters state 704 in which the telephone request is handled. After handling the telephone request, the pocket 104 then enters state 706 in which the telephone request is sent to the docking station 106. Next, the pocket 104 awaits a message from the docking station 106 in state 708. If no message is received from the docking station 106, the pocket 104 then returns to state 702. A system 100 also includes the timer that operates in cooperation with determining whether or not a message is received. During normal operation, when no response is received from the docking station 106, another pulse or heartbeat is sent at predetermined times. However, if there is no response within a time interval associated with the timer timing out, a hardware reset line is enabled to reset the docking station 106. Where a docking station 106 message is received, the pocket handles the message in state 710, following which it returns to state 702. Where no telephone message is received, the pocket 104 periodically polls the docking station 106 at state 712. According to an embodiment of the present invention, the pocket 104 polls the docking station 106 every 72 milliseconds (i.e., the pocket 104 heartbeat rate is 72 milliseconds). After polling the docking station 106 in state 712, the pocket 104 enters state 708 in which it awaits a message from the docking station 106. If no message from the docking station 106 is received within 10 milliseconds of polling the docking station 106, the pocket 104 returns to state 702, in which it awaits a telephone 102 message. According to one embodiment of the present invention, communications between the pocket 104 and the docking station 106 occur at 19,200 baud, using eight data bits, no parity bits, and two stop bits. According to another embodiment of the present invention, the data between the pocket 104 and the docking station 106 is transmitted at 115200 bps, using 8 data bits, no parity, and one stop bit. However, other communication rates can be used, and may even be varied.

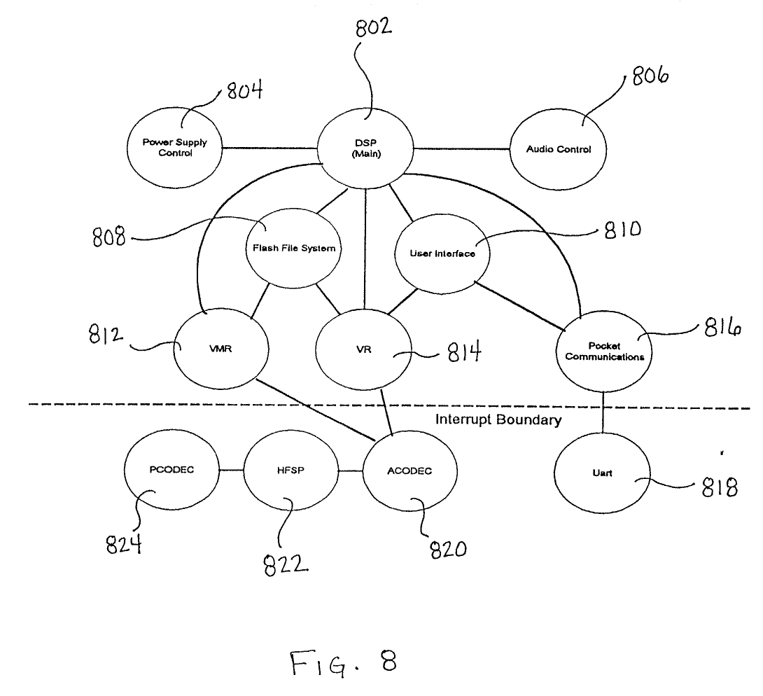

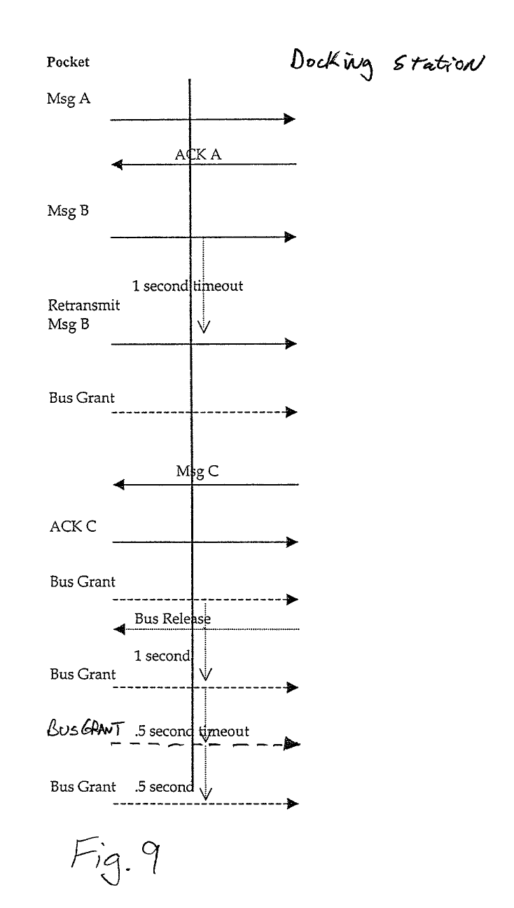

Referring now to FIG. 8, the architecture of the docking station 106 software showing the relationships among the various software objects, is illustrated. In general, the top level loop is the digital signal processor object 802. Thus, the power supply control 804, audio control 806, flash file system 808, user interface 810, voice memo recording 812, voice recognition 814, and pocket communications 816 objects can all be entered from the main loop 802 directly. Other software objects or modules are addressed in response to interrupts. Accordingly, communications between the pocket 104 and the docking station 106 generate an interrupt causing the software to enter the UART object 818. Activity concerning the near-end CODEC 334 is handled at object 820 across the interrupt boundary from the voice memo recording 812 and voice recognition 814 objects. Sound processing 822 and far-end CODEC 824 objects are associated with the near-end CODEC 820 object.

The progression of typical communications scenarios are illustrated in FIG. 9. In FIG. 9, message A is shown originating in the pocket 104. An acknowledgment of message A originates in the docking station 106, and is transmitted to the pocket 104. A second message, message B, originates at the pocket 104, and is passed to the docking station 106. After a one second time out, during which no message is received at the pocket 104, message B is retransmitted. Next in the diagram, the pocket 104 issues a bus grant message. In response to the bus grant, the docking station 106 issues a pending message, message C. In response to message C, the pocket 104 issues an acknowledgment. The pocket 104 next issues another bus grant. In response, the docking station issues a bus release message, as the docking station has no pending message. After one second, the pocket 104 again issues a bus grant message. Receiving no reply, after a 0.5 second time out, the pocket 104 issues a second bus grant message. Again receiving no reply, the pocket 104 issues yet an other bus grant message. The above-described typical scenarios serve as examples, and it will be appreciated that additional alternative scenarios are possible.

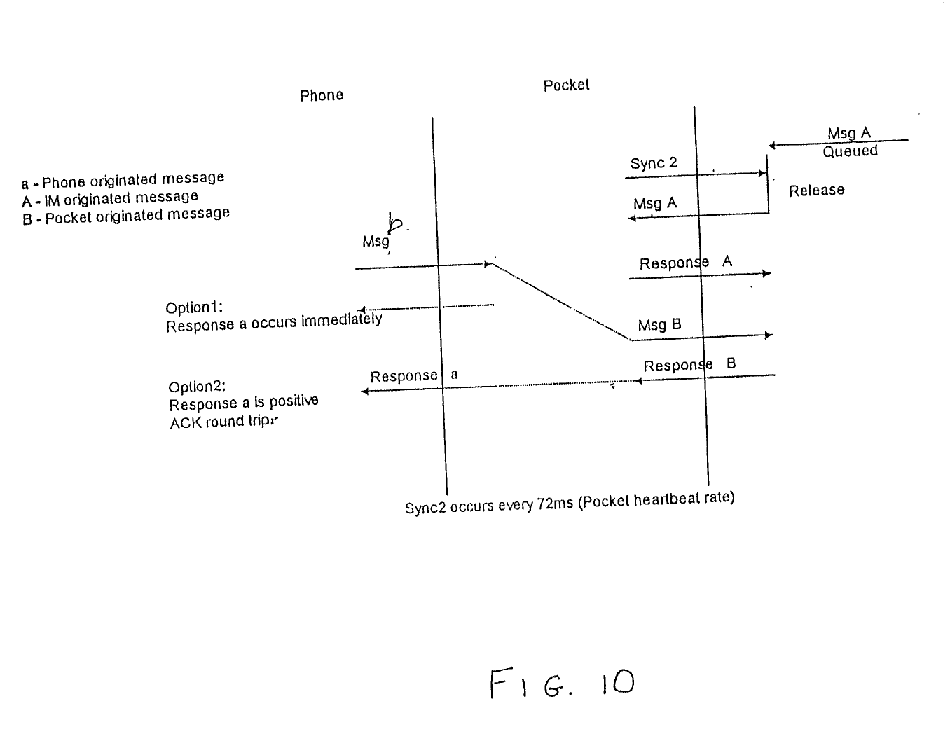

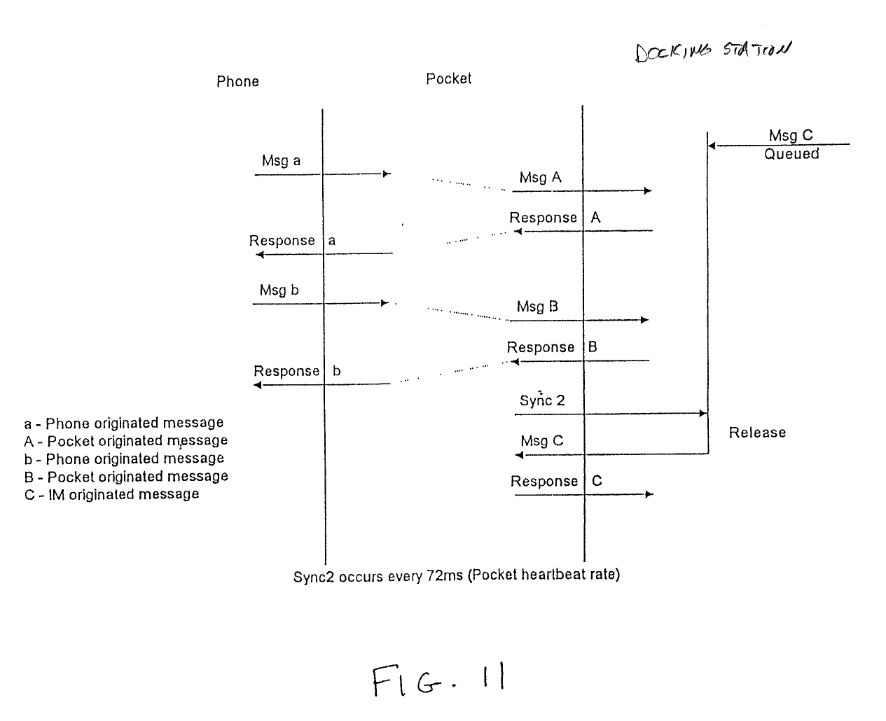

With reference now to FIG. 10, a pocket 104 worst case scenario is illustrated. In FIG. 10, message A, is shown queued in the docking station 106. Message A is released after synch 2 to the pocket 104. At the time Message A is released, Message b is received from the telephone 102. In response to this situation, the pocket can immediately pass Message A to the telephone and return Response A to the docking station, while delaying handling of Message B from the telephone, or the pocket can communication Message B to the docking station as Message B while delaying the handling of Message A.

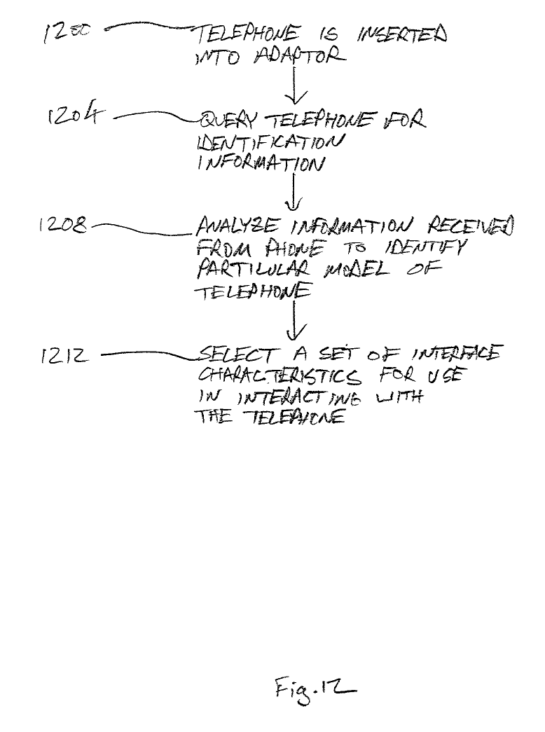

With reference now to FIG. 11, a docking station 106 worst case scenario is illustrated. In FIG. 11, Message C is shown queued in the docking station 106. Shortly after Message C is queued, Message a is received at the telephone 102 and is communicated through the pocket 104 and to the docking station 106 as Message A. Then while Message C continues to be queued, Response A is communicated to the telephone 102 as Response a. Message B is then received at the telephone 102 and is communicated to the docking station 106 through the pocket 104 as Message B. The docking station 106 then sends Response B through the pocket 104 into the telephone 102 as Response b. Following the receipt of Response b at the telephone 102, a synchronization signal, labeled Synch 2, is sent from the pocket 104 to the docking station 106, causing the release of the queued message. Message C is then delivered to the pocket 104, and Response C delivered from the pocket 104 to the docking station. Therefore, in this worst case scenario, Message C could not be handled until Messages A and B had been dealt with, and the synchronization signal received.

According to one embodiment of the system 100 of the present invention, the docking station 106 is provided with programming instructions necessary for communicating with the telephone 102. According to this embodiment, the pocket 104 need not be provided with a microprocessor 320 or memory 324. Instead, the pocket 104 may simply provide a physical interconnection to the telephone 102, and for the transfer of signals from the telephone 102 directly to the docking station 106. Where the docking station 106 is not intended to interconnect to telephones 102 having a variety of physical characteristics, the pocket 104 need not be a component that is separate and distinct from the docking station 106. According to one embodiment, the docking station 106 may be provided with programming code enabling it to interface with a variety of telephones 102. Thus, the pocket 104 may provide a signal to the docking station 106, for example, by providing differing voltage levels at input pins associated with the docking station 106 microprocessor 328 to indicate the type and capabilities of the telephone 102. The docking station 106 may use this information to select the appropriate command set for communicating with the telephone 102. The docking station 106 may be upgraded to provide advanced capabilities, or to communicate with additional telephones 102 through upgrades to the programming code generally stored in the docking station memory 340. The upgrades may be provided to the docking station 106 by interconnecting the docking station 106 to a personal computer that has read or downloaded the code upgrade, or by downloading the upgrade through an Internet-enabled telephone 102 directly to the docking station 106.

The text to speech functionality described above with respect to certain embodiments of the present invention may be augmented by the ability to visually display textual information. Accordingly, textual information may be displayed, for example, on a screen associated with an external subsystem 378. Thus, textual information may be displayed on the screen of a personal digital assistant (PDA), a personal computer, or a display screen provided by the automobile 302. The system 100, upon receipt of textual information, may in a default mode provide a visual output of text where a visual display is interconnected to the system, and an audible output. The user may also select whether textual information is to be provided audibly or visually. For example, a user may command the system 100 to “read e-mail.” Alternatively, the user may command the system 100 to “display e-mail.”

The system 100, particularly in connection with an automobile 302, may provide a variety of useful, automated functions. For example, the docking station 106 may be provided with a custom interface 348 that includes a telematics module to monitor activity occurring on an external subsystem 378. For instance, where a first external subsystem 378 is a vehicle bus, a message indicating a low fuel status transmitted over the bus may be decoded by the custom interface 348. The custom interface 348 may then cause a query to be transmitted over the wireless link provided by the telephone 102 to a central station interconnected to the Internet. The query, which may be transmitted from the telephone 102 according to the Internet protocol, may request the location and prices of fuel available in the area. The response to the query may be provided to the user of the system 100 through a visual display provided as, for example, a second external subsystem 378, or may be provided audibly to the user through the text to speech capabilities of the system 100. According to one embodiment, the query includes information concerning the location of the automobile 302. Such information may be provided automatically, for example, from a GPS receiver interconnected to the system 100 as a third external subsystem 378. Alternatively, location information may be provided by a telephone 102 capable of receiving GPS data.

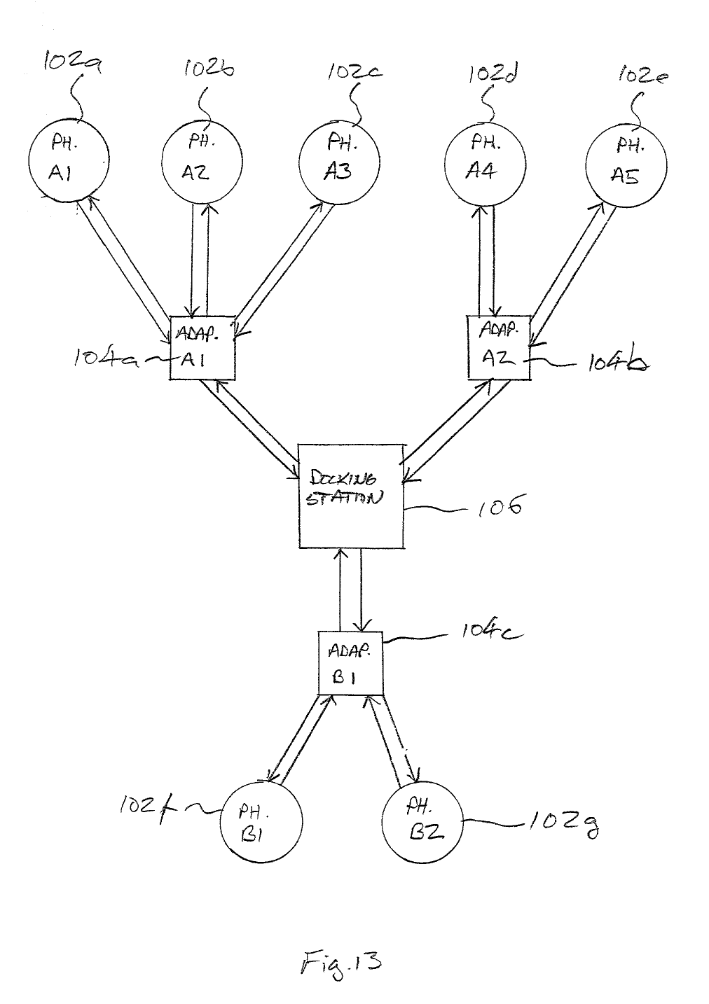

With reference to FIG. 12, the operation of a system in accordance with an embodiment of the present invention is illustrated. In particular, FIG. 12 illustrates the acquisition of identification information from a telephone 102 by the docking assembly 107.

Initially, at step 1200, the user inserts the telephone 102 into the adaptor 104. The docking assembly 107 detects the insertion of a telephone 102 into the adaptor 104 by, for example, sensing a change in voltage at a contact included as part of the electrical connectors 116 or 124. Alternatively, the pocket 104 may be provided with a mechanical or optical switch for providing an electrical signal to indicate the presence of a telephone 102.

Upon detecting the presence of a telephone 102 in the docking assembly 107, the telephone 102 is queried for identification information (step 1204). In general, this is accomplished by requesting identification or identification-related information from the telephone 102. Alternatively, the telephone 102 may automatically provide identification information when it is interconnected to another device, such as the docking assembly 107. The identification information may be provided in a variety of ways. For example, the identification information may be provided as a data stream. For instance, the identification information may be contained in a particular word within a string of words provided by the telephone 102 when it is placed in the docking assembly 107 or in response to a query. The location of the identification information needed to identify the phone may be predetermined. Alternatively, the identification information may be preceded by a particular code word or pattern of characters. As a further example, the set of messages that can be generated by the telephone 102 may be used as the identification information. The set of messages that can be generated can be determined by providing queries or commands to the telephone 102 to determine whether a message or messages that are unique to a particular model or set of telephones 102 are generated in reply. In connection with certain telephones 102, a set of messages is automatically generated when the telephone 102 is placed in the docking assembly 107, and the automatically generated set of messages can be used to determine the particular model or set of telephones 102.

The identification information may include information regarding the particular model of telephone 102, the type of telephone 102 (e.g., the wireless transmission standard used by the telephone 102), or the data format required by the telephone in order to transmit data or audio. As mentioned above, the identification of a telephone 102 may also be inferred from the set of messages produced by that telephone 102. Because the identification information provided may vary between telephones provided by different manufacturers, and between different models of telephones 102 provided by a single manufacturer, the docking assembly 107 must be capable of undertaking an appropriate analysis of the identification information in order to extract the particular information relevant to identifying the telephone 102 model. In general, the permutations of identification information format that the docking assembly 107 must be capable of extracting relevant information from will be narrowed by the fact that a particular docking assembly 107 will be capable of receiving only those telephones 102 having physical characteristics to which the docking station, and in particular the adaptor 104, is adapted. At step 1208, the information parsed from the identification information is analyzed to identify the particular model of telephone 102 that has been placed in the docking assembly 107.

There are a variety of reasons why it may be important for the docking assembly 107 to identify the particular model of telephone 102 that has been received by the docking assembly 107. For instance, different telephone 102 models may require different commands or command sequences in order to perform a particular function. For example, the dial string required by the telephone 102 in order for the telephone to dial a particular number may differ between telephone 102 models. As a further example, some telephone 102 models may provide an indication of the telephone's 102 power state, allowing power supplied by the docking assembly 107 to the telephone 102 to be accurately controlled, while other telephone 102 models may not. As still another example, the utilization of air link requirements of the telephone 102 and functions, such as how data for transmission by the telephone 102 must be formatted and what commands must be provided to the telephone 102 in connection with the transfer of data, may differ between telephone 102 models. Therefore, the particular model of telephone 102 placed in the docking assembly 107 must often be ascertained in order to ensure that the docking assembly 107 can adequately control (i.e. generate appropriate control information) or communicate with the telephone 102.

With continued reference to FIG. 12, at step 1212, the docking assembly 107 selects a set of interface characteristics or control information for use in interacting with the telephone 102. As noted above, the particular set of interface characteristics selected is dependent upon the determination that the docking assembly 107 has made regarding the model of telephone 102 that has been placed in the docking assembly 107. As also noted above, the interface characteristics selected by the docking assembly 107 may include any signal provided to the telephone 102 by the docking assembly 107. Accordingly, the interface characteristics may include the power supplied to the telephone 102 (i.e., the current or voltage supplied), the set of commands used for communicating control information between the telephone 102 and the docking assembly 107, the sequence or commands required to initiate use of the telephone 102, the format of data passed between the telephone 102 and the docking assembly 107, whether audio signals are passed between the telephone 102 and the docking assembly 107 as analog or digital data, and the functions of the telephone 102 that the docking assembly 107 will control.

With reference now to FIG. 13, a plurality of pockets or adaptors A1 104a, A2 104b, and B1 104c are shown, each having differing physical and/or functional compatibilities, but that are all physically and functionally compatible with a common docking station 106. Alternatively, according to one embodiment of the present invention, the adaptors 104a-104c may each be integrated with a docking station 106 to form an integrated docking assembly 107. According to the present example, the pockets A1 104a and A2 104b, may be compatible with various telephone 102 models produced by manufacturer A. For instance, adaptor A1 104a may be compatible with telephones A1 102a, A2 102b and A3 102c. Additionally, adaptor A2 104b may be compatible with telephones A4 102d and A5 102e. Although telephones 102a-102e are all produced by manufacturer A, those telephones 102a-102e are provided in two different physical configurations. That is, the physical characteristics of telephones A1 102a, A2 102b, and A3 102c are such that those telephone 102a-102c can be mechanically and electrically connected to adaptor A1 104a. Telephones A4 102d and A5 102e have physical characteristics such that they can be mechanically and electrically connected to adaptor A2 104b. However, telephones A1 102a, A2 102b and A3 102c cannot be mechanically and electrically interconnected to adaptor A2 104b, and telephones A4 102d and A5 102e cannot be mechanically and electrically interconnected to adaptor A1 104a.

In addition, according to the present example, it is assumed that each of the telephones A1 102a, A2 102b, A3 102c, A4 102d and A5 102e are different models. For example, telephone A1 102a may be a model for use in connection with a code division multiple access (CDMA) telephone system, telephone A2 102b may be adapted for use in connection with a time division multiple access (TDMA) telephone system, and telephone A3 102c may be adapted for use in connection with a global system for mobile communications (GSM) telephone system. Furthermore, although the various communications standards under which the telephones A1 102a, A2 102b, and A3 102c operate do not themselves require different docking assemblies 107, each of the telephones A1 102a, A2 102b, and A3 102c may each require a different command set in order for a docking assembly 107 to interact with them. This may be, for example, a result of the design choices made by manufacturer A. For instance, the command sets may be different in that the commands are formatted differently, or like commands may need to be entered in a different sequence between one telephone 102 and another. Because different command sets are required for each of the telephones A1 102a, A2 102b, and A3 102c, and because the physical characteristics of these telephones are identical, the adaptor A1 104a must be capable of identifying the particular model of telephone 102 and selecting the appropriate command set. Where the docking assembly 107 is provided as an adaptor 104 that is separable from the docking station 106, the processing of the identification information received from the telephone 102 (step 1208) may be conducted in the microprocessor 320 provided as part of the adaptor 104. In particular, the microprocessor 320 included in the adaptor 104 can be provided with programming code capable of identifying the model of telephone 102 from among those models of telephone 102 that are capable of being received by that adaptor 104.

Likewise, telephones A4 102d and A5 102e may utilize distinct command sets, therefore requiring adaptor A2 104b to distinguish between the telephones A4 102d and A5 102e. For example, telephone A4 102d may be adapted for use in connection with an advanced mobile phone service (AMPS) system and use one set of commands, while telephone A5 102e may be adapted for use in connection with a CDMA system and use another set of commands.

Accordingly, it is apparent that adaptor A1 104a should be provided with programming code capable of identifying the model of telephone received by the adaptor 104a from among telephones A1 102a, A2 102b and A3 102c, but need not be able to distinguish between telephones A4 102d and A5 102e, as the physical characteristics of those telephones do not allow them to be received by adaptor A1 104a. Similarly, adaptor A2 104b should be provided with programming code to enable it to distinguish between telephones A4 102d and A5 102e. However, adaptor A2 104b does not need to be capable of distinguishing between telephones A1 102a, A2 102b and A3 102c, as the physical characteristics of those telephones do not allow them to be received by adaptor A2 104b.

Adaptor B1 104c may be adapted for receiving telephones 102 manufactured by manufacturer B and having a particular set of physical characteristics. In the example of FIG. 13, adaptor B1 104c is capable of receiving and interacting with telephones B1 102f and B2 102g. According to the present example, telephones B1 102f and B2 102g may be operated using the identical command sets. However, other interface characteristics of the telephone B1 102f may differ from those of telephone B2 102g. For example, the telephones 102f-g may provide different information regarding their power state. For instance, telephone B1 102f may indicate, through an electrical signal provided to adaptor B1 104c, the user's attempt to power off the telephone B1 102f, while telephone B2 102g may not provide any such indication. The adaptor B1 104c is preferably capable of distinguishing between telephones B1 102f and B2 102g so that adaptor B1 104c can use appropriate interface characteristics with a received telephone 102f or 102g. In particular, adaptor B1 104c is preferably configured so that it controls the power state of telephone B1 102f, but does not control the power state of telephone B2 102g.

As a particular example of telephone models requiring different command sets, reference will now be had to Table 1. In Table 1, various models of wireless telephones 102 available from NOKIA® MOBILE PHONES, INC. are shown. As shown in Table 1, various model types of NOKIA® telephones 102 are listed, together with their corresponding model number and telephone protocol. In general, the telephone protocol refers to the set of commands required to operate a telephone 102 when it is placed in a docking assembly 107. Accordingly, it can be appreciated that, even though all of the listed telephone models may be physically received by a docking assembly 107, the docking assembly 107 must use the particular set of interface characteristics (i.e. telephone protocol) associated with the received telephone 102. Therefore, in order to successfully control dialing of the different NOKIA® telephone models, it is important to identify the particular model type of a telephone 102 placed in the docking assembly 107. As illustrated in Table 1, the telephone model, and therefore the telephone protocol, can be identified from the model type. The model type is returned by a Nokia telephone 102 in response to a telephone identification query. In particular, the model type telephones 102 listed in Table 1 is provided at an electrical connector 116 as part of a serial message in response to the query. The docking assembly 107 may then ascertain the model type by decoding the serial message provided by the telephone 102.

TABLE 1

| MODEL TYPE | PHONE MODEL | PHONE PROTOCOL |
|---|---|---|
| NSC-1 | 5120 | TDMA1 |
| NSC-3 | 6120 | TDMA1 |
| NSW-1 | 5160 | TDMA1 |
| NSW-? | 5165 | TDMA1 |
| NSW-3 | 6160 | TDMA1 |
| NSW-5 | 7160 | TDMA2 |
| NSB-1 | 5190 | GSM1 |
| NSB-1 | 6190 | GSM1 |
| NSE-1 | 5110 | GSM1 |
| NSM-? | 6150 | GSM1 |
| NSE-5 | 6210 | GSM2 |
| NPE-3 | 7110 | GSM2 |
| NSD-1 | 5170 | CDMA |
| NSD-? | 5185 | CDMA |
| NSD-3 | 6185 | CDMA |

As a further example of different telephone models having different interface characteristics, certain telephone models may not support the same message types as other of the telephone models. For example, the 6210 and 7110 telephone models listed in Table 1 may not provide a message indicating that a telephone 102 is being powered off. Because the same message is used to turn the telephones 102 listed in Table 1 on or off, telephones 102 such as the 6210 and 7110 listed in Table 1 cannot have their power state controlled by the docking assembly 107, as the docking assembly 107 might otherwise turn on a telephone 102 after it has already been turned off manually.

With reference now to Table 2, various telephone models available from MOTOROLA®, INC., together with each phone's corresponding telephone protocol, are illustrated. The various telephone models listed in Table 2 are not identified by querying the telephone 102 for a model type. Instead, the messages generated by the telephones 102 listed in Table 2 after they have been placed in the docking assembly 107 are analyzed by the docking assembly 107 to determine the message set supported by a particular telephone 102. Once the message set supported by the telephone 102 is determined, the docking assembly 107 uses that message set in communicating with the telephone 102. In addition, depending on the message set of the telephone 102, and therefore on the particular telephone model, various functionalities may or may not be supported. For example, the CDMA type telephones 102 appearing in Table 2 do not provide an indication as to whether the telephone has been turned off or not. Because the same command is used to turn the telephones 102 using a CDMA phone protocol off and on, the docking assembly 107 does not attempt to control whether such a telephone 102 is off or on. This is because the docking assembly 107 may inadvertently turn on a telephone 102 that has already been turned off, for example by a user.

TABLE 2

| PHONE MODEL | PHONE PROTOCOL |
|---|---|
| StarTac 3000 | Analog |
| StarTac 6500 | Analog |
| StarTac ST7760 | CDMA |
| StarTac ST7762 | CDMA |
| StarTac ST7790 | TDMA |
| StarTac ST7790i | TDMA |
| StarTac ST7790si | TDMA |
| StarTac ST7797 | TDMA |
| StarTac ST7860W | PCS |
| StarTac ST7867W | PCS |
| StarTac ST7868W | PCS |

An example of messages that may be generated by the telephones 102 listed in Table 2 are set forth in Table 3. As mentioned above, when one of the listed telephones from Table 2 is received by a docking assembly 107, the telephone 102 will automatically output one or more of the messages set forth in Table 3. By analyzing the intersection of the messages in Table 3 with the telephone protocols capable of generating those messages, the telephone protocol of the telephone 102 received by the docking assembly 107 can be determined. For the telephones 102 of the present example (i.e., the telephones 102 listed in Table 2), all of the telephones 102 except those using the CDMA protocol will output at least one message to assist in identification. Therefore, if no uniquely identifying message, or no message at all, is received, the telephone 102 can be identified as one that uses the CDMA phone protocol.

TABLE 3

| | | SUPPORTED BY PHONE |
|---|---|---|
| MESSAGE | MESSAGE TYPE | PROTOCOL |
| 7A 0A | Suspend - Phone turned off | Analog, TDMA, PCS |
| 7A 1C | Low battery mode disabled | Analog, TDMA, PCS |
| 7A 81 | Initialization, channel scan | Analog, TDMA, PCS |
| 7A 82 | Paging channel scan | TDMA |
| 7A 83 | Idle, in service | Analog, TDMA, PCS |
| 7A 84 | Page | Analog, TDMA, PCS |
| 7A 85 | Origination | Analog, TDMA, PCS |
| 7A 86 | Order response | Analog, TDMA, PCS |
| 7A 87 | Registration | Analog, TDMA, PCS |
| 7A 88 | Waiting for answer | Analog, TDMA, PCS |
| 7A 89 | Waiting for order | Analog, TDMA, PCS |
| 7A 8B | Handoff | Analog, TDMA, PCS |
| 7A 8C | Intercept | PCS |
| 7A 8D | Reorder | Analog, TDMA, PCS |
| 7A 8E | Release | Analog, TDMA, PCS |
| 7A 8F | SAT, channel loss | Analog, TDMA, PCS |
| 7A 9A | Primary conversation mode | Analog, TDMA, PCS |
| 7A B0 | Transmitter on | CDMA, Analog, TDMA, PCS |
| 7A B1 | Transmitter off | CDMA, Analog, TDMA, PCS |
| 7A C0 | Sync channel acquisition | PCS |
| 7A C1 | Timing change | PCS |
| 7A C3 | Update overhead | PCS |
| | information | |
| 7A C5 | Traffic channel | PCS |
| | initialization | |

In accordance with the present invention, a method and apparatus for hands-free wireless communications are provided. The invention in its broader aspects relates to an economical method and apparatus for providing various levels of hands-free functionality in combination with wireless communications devices. In particular, the present invention provides a method and apparatus allowing for a wide variety of telephones and pockets to be used with a common docking station.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include alternative embodiments to the extent permitted by the prior art.

What is claimed is:

1. A method for using information related to an identification of a portable communications device, comprising:
providing a first portable communications device, having a first make and a first model, with a docking assembly;
obtaining from said first portable communications device identification-related information that can be used to identify said first portable communications device; and
controlling at least one of: power to said first portable communications device; initiation of use of said first portable communications device; and utilization of air link requirements of said first portable communications device based on said identification-related information.

2. A method, as claimed in claim 1, wherein:
said first portable communications device includes a first cellular telephone and said docking assembly includes a pocket member that holds said first portable communications device and in which said first cellular telephone is one of a plurality of cellular telephones being associated with said first make and, wherein each of said plurality of cellular telephones is associated with a different model.

3. A method, as claimed in claim 2, wherein:
said plurality of cellular telephones includes a second cellular telephone and in which said second cellular telephone has physical characteristics including dimensions such that said second cellular telephone can be held by said first pocket member.

4. A method, as claimed in claim 3, further including:
providing a third cellular telephone and a second pocket member for holding said third cellular telephone and in which said third cellular telephone has physical characteristics including dimensions that prevent it from being properly used with said first pocket member and in which said first and second cellular telephones have physical characteristics including dimensions that prevent it from being properly used with said second pocket member.

5. A method, as claimed in claim 1, wherein:
said identification-related information includes at least a first message obtained from said first portable communications device.

6. A method, as claimed in claim 5, wherein:
said first message includes information related to at least one of: a model type and a phone type associated with said first portable communications device.

7. A method, as claimed in claim 1, wherein:
said obtaining step includes recognizing a predetermined portion of a first message obtained from said first portable communications device that includes information related to a model type associated with said first portable communications device.

8. A method, as claimed in claim 1, wherein:
said identification-related information includes a message type that is indicative of a data format used by said first portable communications device.

9. A method, as claimed in claim 1, wherein:
said first portable communications device includes a first cellular telephone and said initiation of use includes dialing said first cellular telephone and said air link requirements include a data format associated with data that can be transferred using said first cellular telephone.

10. A system for using information related to identification of at least a first portable communications device, comprising:
a docking assembly for communicating with said first portable communications device and including:
a first adaptor for holding and supporting the first portable communications device; and
a docking station for enabling communications with a number of portable communications devices including said first portable communications device;
wherein said docking assembly receives identification-related information for the first portable communications device that can be used to identify it and, using said identification-related information, generates control information related to at least one of the following: powering on the first portable communications device; initiating use of the first portable communications device; and utilizing a predetermined data format for the first portable communications device.

11. A system, as claimed in claim 10, wherein:
said docking assembly generates a request to obtain said identification-related information when said adaptor is holding the first portable communications device.

12. A system, as claimed in claim 10, wherein:
said control information is part of a message received by said adaptor.

13. A system, as claimed in claim 10, wherein:
said docking assembly includes software for checking at least a first predetermined portion of a message received by said adaptor.

14. A system, as claimed in claim 10, further including:
a first cellular telephone that is the first portable communications device, said first cellular telephone being associated with a make and a first phone type and with said first cellular telephone inputting said identification-related information to said adaptor.

15. A system, as claimed in claim 14, further including:
a second cellular telephone having the same make of said first cellular telephone make and being associated with a second phone type and in which said second cellular telephone can be held and supported by said adaptor.

16. A system, as claimed in claim 10, wherein:
said control information includes said initiating use that is used to dial said first cellular telephone.

17. A system, as claimed in claim 14, wherein:
said first phone type includes at least one of a first phone model and a message type and said at least one being used to ascertain said predetermined data format associated with said first cellular telephone.

18. A method for interacting with a portable communications device, comprising:
receiving a first portable communications device in a docking assembly;
eliciting an identification signal from said first portable communications device;
receiving said identification signal at said docking station;
using said identification information to identify said first portable communications device; and
selecting a first set of interface characteristics for operating said first portable communications device, wherein said first set of said interface characteristics is capable of operating said first portable communications device, and wherein said first set of interface characteristics is incapable of operating a second portable communications device.

19. The method of claim 18, wherein said second portable communications device is incapable of being received by said docking assembly.

20. The method of claim 18, further comprising:
receiving a third portable communications device in said docking assembly;
eliciting an identification signal from said third portable communications device;
receiving said identification signal at said docking assembly;
using said identification information to identify said third portable communications device;
selecting a second set of interface characteristics for operating said third portable communications device, wherein said second set of said interface characteristics is capable of operating said third portable communications device, and wherein said second set of interface characteristics is incapable of operating said first portable communications device.

21. The method of claim 18, wherein said docking assembly comprises an adaptor and a docking station, wherein said first portable communications device is received by a first adaptor, and wherein said first adaptor is interconnected to a first docking station.

22. The method of claim 20, wherein said docking assembly comprises an adaptor and a docking station, wherein said first portable communications device is received by a first adaptor, wherein said first adaptor is interconnected to a first docking station, wherein said third portable communications device is received by a second adaptor, and wherein said second adaptor is interconnected to said first docking station.

23. The method of claim 18, wherein said first set of interface characteristics comprises control commands.
